(19) United States
(12) Patent Application Publication
(10) Pub. No.: US 2017/0039583 A1
(43) Pub. Date: Feb. 9, 2017

(54) Social Network Driven Real-Time Multi-Payer, Multi-Merchant, Multi-Bucket Discounting Social Commerce System With Value Tracking, Multi-Layer Commission Forwarding And Discount Processing Systems And Related Methods

(71) Applicant: Nebil Ben Aissa, Chicago, IL (US)

(72) Inventor: Nebil Ben Aissa, Chicago, IL (US)

(21) Appl. No.: 15/209,023

(22) Filed: Jul. 13, 2016

Related U.S. Application Data
(63) Continuation of application No. 13/841,124, filed on Mar. 15, 2013, now abandoned.
Application No. 13/841,124 is a continuation-in-part of application No. 13/532,449, filed on Jun. 25, 2012, now abandoned.
(60) Provisional application No. 61/501,062, filed on Jun. 24, 2011.

(51) Int. Cl. G06Q 30/02; G06Q 30/06; G06Q 20/28; G06Q 50/00

(52) U.S. Cl. CPC G06Q 30/0214; G06Q 50/01; G06Q 30/0601; G06Q 30/0226; G06Q 30/0239; G06Q 20/28; G06Q 30/0235; G06Q 30/0213

(57) ABSTRACT

Methods for a buyer to receive a discount from a merchant or another member in a multi-merchant, multi-payer internet commerce platform in a social network. The methods relate to deals which include loyalty-based discounts, prepaid discounts and/or coupon discounts. A buyer may wish a deal form a selected merchant at a selected discount. Upon acceptance by the merchant, the deal is published and available to all members. Existing members may sponsor friends or businesses to become members of the internet commerce platform. New businesses listed on the internet commerce platform are subject to verification by current members entering business telephone numbers and determining if the entered numbers match. Further verification may include an interactive voice response test performed on the business manager's mobile telephone number.

### CROSS-REFERENCE TO RELATED APPLICATION

This non-provisional patent application is a continuation-in-part patent application which claims the benefit of U.S. non-provisional patent application Ser. No. 13/532,449, filed on Jun. 25, 2012, and which claims the benefit of U.S. provisional patent application Ser. No. 61/501,062, filed on Jun. 24, 2011. Both of these prior patent applications are incorporated herein in their entirety.

### FIELD OF THE INVENTION

The present invention relates generally to methods and systems which enable buyers to get various types of discounts on their purchases from merchants on an internet commerce platform which operates on a social network site.

### BACKGROUND OF THE INVENTION

A comprehensive background is provided in prior application Ser. No. 61/501,062, now U.S. Patent Application Publication No US 2012/0330744 A1, and is not repeated herein.

### SUMMARY OF THE INVENTION

The present invention is concerned with methods for a buyer to receive a discount in a multi-merchant, multi-payer internet commerce platform in a social network where connected social network members get variable commissions for forwarding a discount to other interconnected members. One such method includes the steps of logging in to a social network account of the buyer, signing up for a discount deal on the internet commerce platform, searching for discount deals of interest, purchasing a discounted deal, paying for the purchased deal, receiving a code on an electronic communication device, the code is associated with the purchased deal and the code is associated with a specific merchant, and using the code to complete the purchase with the merchant.

The purchased deal may include a loyalty-based discount where the buyer receives a specified fixed discount or percent discount on a subsequent purchase within a specified time period, or a specified discount upon the buyer prepaying the purchased deal, or a physical coupon with a specified discount which can be used to obtain the discount at a specific merchant.

The methods further include a method of forwarding a deal to one or many individuals via email or via interconnections via a social network in a multi-merchant, multi-payer internet commerce platform running on top of a social network. Such methods may include the steps of searching for a deal with a sizeable forwarding commission amount, previewing the associated amount of commission which varies on how many prior forwards it has reached the specific individual, then selecting a plurality of users to forward the deal to, forwarding the deal to the plurality of selected users. If the selected users to whom the deal was forwarded make a purchasing decision, then the forwarder gets the largest portion of the commission, which is determined via a proprietary variable commission forwarding algorithm. If the selected users do not buy but forward the deal to others whom either buy or forward again, then the original forwarders of the deal get a smaller commission portion. Meanwhile the forwarders who produce an eventual buyer are awarded the largest portion of the commission. The Forward commission amount is calculated by rewarding those that produce buyers, however those that forward and produce further forwarders are also rewarded but at a much smaller portion when compared with those that produce a sale. Note that as we go down through various forward layers, if the deal does not produce an eventual buyer, then the full set of forwarders would get zero commission. Also note that such forward commissions, as they travel more and more forward nodes, get smaller and smaller until the algorithm stops calculating once such forward commission lead into splitting pennies.

The methods further include a method of wishing for a deal at a discount in a multi-merchant, multi-payer internet commerce platform in a social network. Such methods may include the steps of selecting a merchant, selecting a discount amount selecting a plurality of users to forward the deal to, forwarding the wished deal to the plurality of selected users, determining if the wished deal is accepted by a minimum number of selected users, and forwarding the wished deal to the selected merchant if the wished deal is accepted by the minimum number of selected users.

Additional steps of wishing for a deal include withholding the money of those users who accepted the wished deal, determining if the wished deal is accepted by the selected merchant and if so, completing the sale of the wished deal to those users who previously accepted the wished deal, publishing and making the wished deal available to other users of the internet commerce platform, determining the amount of commissions which are due to the sponsor of the wished deal, and paying the sponsor of the wished deal the determined commissions.

Methods for a current member to sponsor a friend or a merchant in a multi-merchant, multi-payer internet commerce platform in a social network are also included. A typical method may include the steps of inviting the friend or merchant to join the internet commerce platform in the social network, the friend or merchant checking a link to the internet commerce platform in the social network for signing up, and automatically updating a profile for the new member or merchant including details about the sponsoring member. Further steps include enabling the new member to buy deals or enabling the new merchant to sell deals on the internet commerce platform in the social network, enabling the new member to make payments for bought deals on the internet commerce platform in the social network, enabling the new merchants to receive payments for sold deals on the internet commerce platform in the social network, determining the amount of commissions which are due to the sponsor of the new member for purchased deals, and paying the sponsor of the new member the determined commissions.

The present invention further includes methods of verifying a new business member in a multi-merchant, multi-payer internet commerce platform in a social network. This method includes the steps of listing the new business on the internet commerce platform in a social network with a business telephone number, listing the new business as an unverified business without displaying the business telephone number, inviting current members to verify this new business including a business telephone number, and determining that the business is verified if any two entered telephone numbers match the telephone number initially entered by the new business.

Further steps of the method of verifying a new business include inviting current members to enter the new business manager's name, his/her email address and his/her mobile telephone number, determining if these three entries match the entries made by other current members, if the three entries match, providing the business manager with an invitation to join the internet commerce platform in a social network, conducting an interactive voice response verification on the business manager's mobile telephone number and if the interactive voice response verification passes, qualifying the new business on the internet commerce platform in a social network.

### BRIEF DESCRIPTION OF THE DRAWINGS

The invention, together with its objects and the advantages thereof, may best be understood by reference to the following description taken in conjunction with the accompanying drawings, in which like reference numerals identify like elements in the figures, and in which:

FIG. 1 is a block diagram illustrating exemplary steps used to process a debit card, credit card or mobile payment device transaction with the multi-merchant real-time discounting systems and methods of the present invention;

FIG. 2 is a process flow diagram illustrating how merchants place offers, how a payer finds the offers, and how acceptance of an offer results in a financial transaction between the payer's bank and the merchant's bank;

FIG. 3 is a diagram illustrating multiple merchants, each merchant making multiple offers to eligible payers, and each merchant provided with multiple value buckets for conducting real-time discount transactions in accordance with the present invention;

FIG. 4 illustrates a flow chart for a multi-bucket account for a multi-merchant point tracking and discounting (MMPTD) for conducting real-time discount transactions in accordance with the present invention;

FIG. 5 illustrates a flow chart for an issuing bank discount reserve pooled account (IBDRPA) for conducting real-time discount transactions in accordance with the present invention;

FIG. 6 illustrates a flow chart for a real-time discounting process for conducting real-time discount transactions in accordance with the present invention;

FIGS. 7A-7D collectively form a block diagram which illustrates the flow of typical steps encountered while processing real-time discount debit card, credit card or mobile payment device transactions in accordance with the present invention;

FIG. 8 illustrates a flow chart of the methods of the present invention utilized within a social network site;

FIGS. 9A-A9C illustrate a flow chart of the methods of providing a buyer with a loyalty-based discount on a social network site in accordance with the present invention;

FIGS. 10A-10B illustrate a flow chart of the methods of providing a buyer with a prepay discount deal on a social network site in accordance with the present invention;

FIGS. 11A-11B illustrate a flow chart of the methods of providing a buyer with a coupon discount deal on a social network site in accordance with the present invention;

FIGS. 12A-12C illustrate a flow chart of the methods of enabling a buyer to wish a deal on a social network site in accordance with the present invention;

FIG. 13 illustrates a flow chart of the methods of enabling a previously registered user to sponsor friends to join an internet commerce system on a social network site in accordance with the present invention;

FIGS. 14A-14B illustrate flow charts on how users may sign up to join an internet commerce system on a social network site and how to transact deals in accordance with the present invention;

FIG. 15 illustrates a flow chart on how new merchants may be sponsored to join an internet commerce system on a social network site in accordance with the present invention;

FIGS. 16A-16B illustrate flow charts describing how new businesses may be on-boarded to the internet commerce site by using a social network in accordance with the present invention;

FIGS. 17A-17B illustrate a flow chart on how a merchant is signed up and how the merchant publishes deals on the internet commerce site by using a social network in accordance with the present invention; and

FIG. 18 illustrates an example of the process of redeeming a voucher at a merchant on the internet commerce site by using a social network in accordance with the present invention.

FIG. 19 illustrates a very simple forward exercise where the forwarder gets 100% of the commission for bringing an actual buyer.

FIG. 20 illustrates a very simple forward exercise where the forwarder gets only 20% of the commission because the person they forwarded the deal to did not buy, however the next person forwarded the deal to a person that bought. Thus the last forwarder gets 80% of the commission, while the original forwarder only gets 20%.

FIG. 21 illustrates a bit more complex forwarding scenario where various forwarders get compensated 100%, 20%, 16% and 64% depending on their forward distance from the eventual buyers.

FIG. 22 illustrates the multiple players in a forwarded deal; such as the merchant, the parent of the merchant (the one that invited the merchant to the system), the deal wisher, the parent of the deal wisher (the one that invited the deal sponsor to the system), then the multiple layers of forwarders up to 12 levels.

FIG. 23 illustrates multiple forward commission calculations in a 12 level standard deal forwarding process, where commissions are illustrated in percentages of the finder's fee commission.

FIG. 24 illustrates multiple forward commission calculations in a 5 level forwarded wish, where commissions are calculated in percentages, thus generating a fixed 20% commission to all forwarders.

### DESCRIPTION OF the PREFERRED EMBODIMENTS

It will be understood that the present invention may be embodied in other specific forms without departing from the spirit thereof. The present examples and embodiments, therefore, are to be considered in all respects as illustrative and not restrictive, and the invention is not to be limited to the details presented herein.

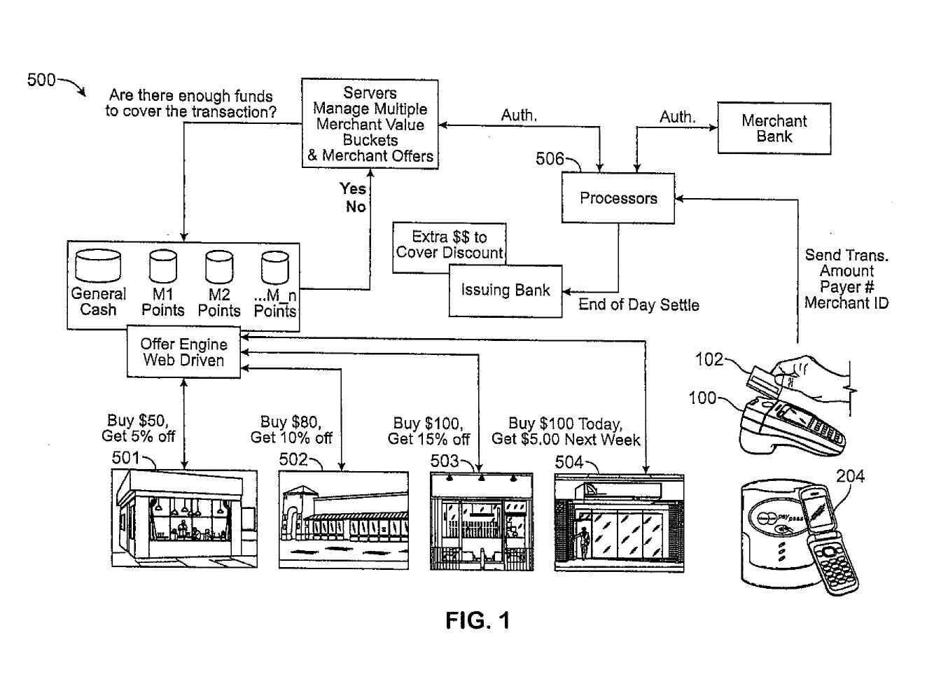

FIG. 1 illustrates the operation of a commercially viable real-time electronic open loop debit card, credit card or mobile payment device discounting system 500 in accordance with the present invention. One objective of these systems and methods is to offer an electronic discounting process without breaking or altering any authorization and settlement transaction bank rules, while operating the real-time discounting system with any off-the shelf POS system such as used by various brick-and-mortar or internet merchants 501-504.

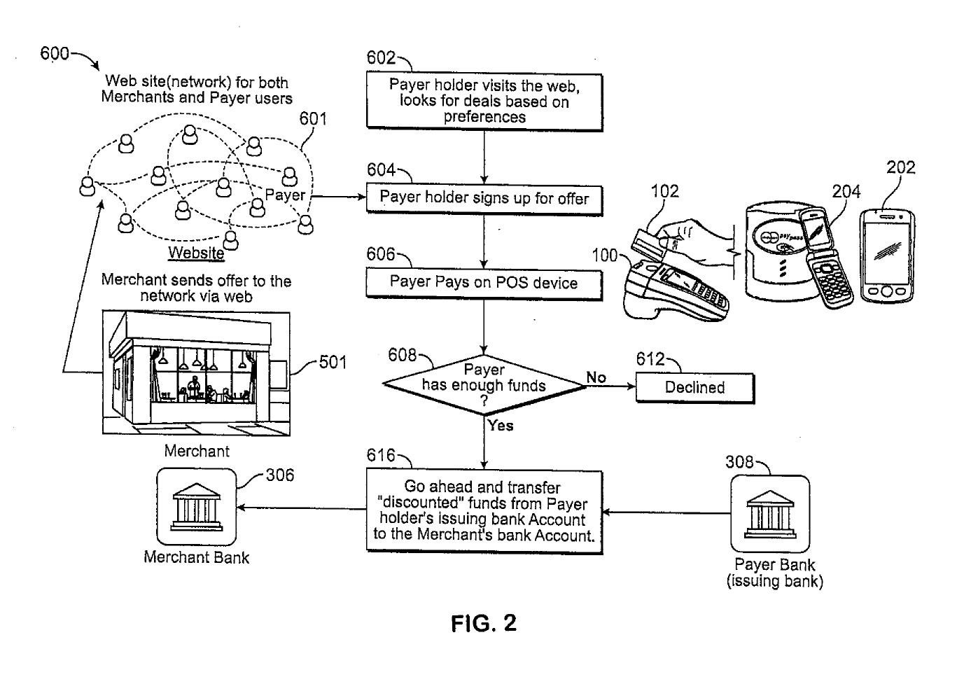

As further shown in FIG. 2, a system is an interconnected multi-payer 601, multi-merchant business oriented social network 600 which connects consumers 601 using debit cards, credit cards or mobile payment devices with local businesses 501 that have a web portal and a Point of Sale (POS) device 102. The system helps buyers save money, it boosts merchant sales and it promotes buying from local small businesses.

Consumers (payers) like the system because they get various real-time electronic discount options by using their credit cards, debit cards or mobile payment devices:
1. Instant electronic discounts
2. Loyalty based electronic discounts,
3. Pre-paid electronic discounts.
4. Avoid embarrassing moments handing paper coupons in front of guests and merchant workers. All that the payers need to do is use their debit cards, credit cards or mobile payment device and immediately receive their discount.

Merchants like the system because they get the following benefits:
1. More client traffic, thus more sales and more potential to up-sell clients.
2. Ability to instantly connect with clients and notify them about special deals and discounts
3. No need to train the merchant's employees on how to discount transactions using paper coupons at the POS device, all discounts are automated and streamlined. Furthermore, there is less opportunity for merchant employee fraud, such as via collusion with consumers.
4. Ability to build loyalty with clients and to give payers incentives to come back and shop regularly.

The operation of the real-time electronic open loop debit card, credit card or mobile payment device discounting systems and methods of the present invention is as follows.

An individual visits a web portal 602 or otherwise learns about the real-time electronic open loop debit card, credit card or mobile payment device discounting, reads about the ability to get instant real-time discounts and decides to participate. He/she then applies to receive a debit card, credit card or enlists their mobile payment device by filling information required to issue a debit card, credit card or register their mobile payment device. He/she must enter personal information such as her name, date of birth, social security number, mobile phone number and any other required information. Once all information is entered correctly and is validated, the system notifies the user that the application process is complete and that the credit card or debit card is scheduled to be shipped to the user, and should be delivered within a few days; or that their mobile device is now registered with the system to received discounts.

The consumer is then issued a universally accepted debit card, credit card supported by an universally accepted international open loop payment network, such as VISA™, MasterCard™, American Express™. In the case the user wants to pay with a mobile payment device, their mobile payment devices is then registered and is tied to a bank account, or a universally accepted debit card or credit card and could be presented at merchants that accept mobile payment devices.

The user then chooses a login and password to the discounting web portal. The payer then activate her account and loads it with funds from a bank account, a credit card, from various electronic funding sources or simply cash from a financial services location which loads cash to a debit card, credit card or mobile device.

Optionally, a user may log onto a social networking website, such as FaceBook (www.facebook.com) and utilize an application (app) to have access to discount offers from merchants. For example, a user may create a wish for a particular discount which may be circulated to friends. Merchants on the website may see the wish and decide whether to accept or to refuse the wish. If accepted, the wish may become a discount available to the user.

The consumer (payer) can now log into the web system and look for merchant sponsored discount offers. For example, an offer could be an instant discount offer such as: “Buy $100.00 worth of goods and get an instant $15.00 discount”; or a loyalty offer such as: “Shop at our store and accrue $200.00 over a month, then come back and get a $30.00 discount on your first transaction after you accrue the $200.00”.

Meanwhile, merchants are recruited to go online and sign up for the discounting web portal system, and are added to the list of merchants offering discounts. The merchant uploads information about its business, so they can create offers which can be broadcasted or otherwise issued to the payers. An offer could be an instant discount offer such as: “Buy $100.00 worth of goods and get an instant $15.00 discount”; or a loyalty offer such as: “Shop at our store and accrue $200.00 over a month, then come back and get a $30.00 discount on your first transaction after your accrue the $200.00”.

Once the merchant completes their application and publishes the discount offer, payers can now go online and register for the published offers, then go to the merchant's locations or web portal and get the promised discounts (step 604).

The discounting web portal system notifies users of special deals offered by various merchants based on user preferences, home address zip code and other location/geo-location details, interests and personal settings. The merchant configures the offer so that interested consumers either pre-pay for the offer or pay down a certain down payment. The down payment amount could also be zero if the merchant prefers not to ask for upfront commitment from the consumer. Signing up for a discount without paying any upfront fees or deposits is like picking up a coupon discount from a free newspaper. The only difference here is that once the user signs up for the coupon discount and it is added to his profile, then they don't need to show up at the merchant's location with a paper coupon. The discount is automatically calculated, subtracted and settled without any effort.

Merchants create and upload various discount offers to the discounting web portal. Discount offers may vary from one merchant to another. However the offers are preferably classified into three main categories:
1. Instant offer: Buy a minimum of X dollars-worth of spending, receive Y dollars (or %) in discounts. This offer enables the payer to get instant discounts on their purchase. For example, the offer could be: spend $100 today at the merchant and get $20 off. With the instant discount, the shopper does not have to accumulate a certain number of buying power, then come back to get the discount (Loyalty model) nor do they have to put up any upfront cash to pre-purchase any spending.
2. Loyalty: If you Purchase X dollars today, then you get Y free spending dollars next time. For example, if you spend $100 today, then you get a $20 discount in your next purchase. This “next purchase” could be (a) with no time limits, or (b) time limited. In other words, if you spend $100 today, then you (a) get a $20 discount at any of your next purchases which could be 5 minutes right after the first purchase; or (2) the $20 discount is only in effect if your next purchase takes place after three days from the first purchase and expires by end of the month.
3. Prepaid: Pre-purchase X dollars-worth of spending for Y dollars (where Y is less than X). For example, pre-purchase $100 worth of spending for $80. Payers go online and pre-purchase a certain amount of spending dollars (value) at a discount; then they go to the merchant's location (or online) and shop.

Based on the three categories described above, the following offer sub-categories are provided:
a. Instant real-time (%) percentage electronic discount: Within a given time period, if you buy more than X with your debit card, credit card or mobile payment device, then you get an immediate Y% discount. For example, the offer could be: If you use your card to buy more than $100.00 between May 1^{st} and May 15^{th}, then you get an immediate real-time 10% off your transaction.
b. Instant real-time fixed amount electronic discount: Within a given time period, if you buy more than X with your debit card, credit card or mobile payment device, then you get an immediate fixed Y discount. For example, the offer could be: If you use your card to buy more than $100.00 between May 1^{st} and May 15^{th}, then you get an immediate real-time fixed discount of $10 off your transaction.
c. Pre-pay electronic discount: Within a given time period, if you pre-pay X using your debit card, credit card or mobile payment device, then you get to spend Y amount at our location or web portal. For example, the offer could be: If you use your credit card, debit card or mobile payment device and pre-pay $80.00 between May 1^{st} and May 15^{th}, then you get to buy goods and services (using your debit card, credit card or mobile payment device) worth $100 at our location or web portal.
d. Accumulated purchase electronic discount: Within a given time period, if you accumulate purchases which exceed X using your debit card, credit card or mobile payment device, then you get to spend Y amount at our location or web portal. buy more than X with your debit card, credit card or mobile payment device, then you get an immediate fixed Y discount. For example, the offer could be: If you use your card to buy more than $100.00 between May 1^{st} and May 15^{th}, then you get an immediate real-time fixed discount of $10 off your transaction.
e. “Next-Time” Instant fixed discount based on prior purchase activities: Within a given time period, if you accumulate purchases which exceed X using your debit card, credit card or mobile payment device, then from date d1 to d2, you get to an instant electronic Y discount at our location or web portal. For example, the offer could be: If you use your card to buy more than $100.00 between May 1^{st} and May 15^{th}, then from June 1^{st} to June 15^{th}, you get an instant real-time fixed discount of $10 off your transaction.
f. “Next-Time” Instant percentage (%) discount based on prior purchase activities: Within a given time period, if you accumulate purchases which exceed X using your debit card, credit card or mobile payment device, then from date d1 to d2, you get to a percent (%) electronic Y discount at our location or web portal. For example, the offer could be: If you use your card to buy more than $100.00 between May 1^{st} and May 15^{th}, then from June 1^{st} to June 15^{th}, you get a 10% real-time off your transaction.
g. Stepwise variable (%) percentage discount based on the number of signed up payers: Within a given time period, if between n to m number of payers are subscribed (signed up) to this offer, and you buy more than X with your debit card, credit card or mobile payment device, then you get an immediate Y% discount; Note that this Y% discount will vary on the number of signed up consumers; for example:
1. 10% discount, 0-100 users are signed up: If you use your card to buy more than $100.00 between May 1^{st} and May 15^{th}, and 0-100 users are signed up for this offer, then you get an immediate real-time 10% off your transaction.
2. 20% discount, 100-200 users are signed up: If you use your card to buy more than $100.00 between May 1^{st} and May 15^{th}, and 100-200 users are signed up for this offer, then you get an immediate real-time 20% off your transaction.
3. 30% discount, 200-300 users are signed up: If you use your card to buy more than $100.00 between May 1^{st} and May 15^{th}, and 200-300 users are signed up for this offer, then you get an immediate real-time 30% off your transaction.

Consumers may then sign up for one or more of the merchant offers (step 604). After receiving the notification from the merchant and based on his/her preference, if interested, the consumer (payer) registers for the offer, and is requested to: (1) Pre-pay for the offer, (2) Pay down a portion of the offer, or (3) simply not pay any money, if the merchant decides not to require any commitment from the consumer.

If payment is required to sign up for the offer, the consumers or payers then pay at the POS or on the web and receive their real-time discounts (step 606). The system is then ready to automatically discount the transaction in real-time at the Point of Sale without authorizing the full amount from the payer.

The systems and methods automatically and in real-time discount the payer's transaction as follows:
1. The payer visits the merchant's physical location or web portal, and transacts using her debit card, credit card or mobile payment device.
2. The consumer uses her debit card, credit card or mobile payment device to pay at the merchant's location, or the user checks out his/her shopping cart using his/her credit card, debit card or mobile payment device.
3. The payment processing system intercepts the card-holder's transaction, identifies that the payer is registered for discounts with the merchant.
4. If the transaction meets the offer specifics mentioned in the prior paragraph, then the payment processing and discounting system takes the following three steps:
   a. It calculates the non-discounted amount, the net discounted amount, and the size of the discount.
   b. The system withdraws only the net discounted amount from the payer's issuing bank account (step 610).
   c. The system then borrows the discount amount from a pool of funds owned by an external entity (not the payer) which is dedicated to restore discounted settlement transactions to their original transaction amount. This is done so that the settlement transaction could successfully go through a universal open loop payment networks.
   d. The system then sends the undiscounted settlement amount (discounted settlement from the payer's account+borrowed discount=original settlement amount). Thus guaranteeing that the settlement amount sent to the merchant account is equal to the settlement amount requested by the POS device or web shopping cart.
5. Once the settlement transaction is successfully processed and settlement funds are deposited into the merchants bank account (where the settled funds are equal to =discounted amount from the payer's bank account+borrowed discount); The system then issues a reverse settlement transaction where the issuing bank is the party requesting the borrowed discount to be settled back into the borrowing pool account. This transaction reversal is of course explained to the merchant and is legally authorized by the merchant upon joining the discounting web portal system. Thus it will not be a surprise for the merchant to see a set of payer to merchant settlement transactions followed by merchant to issuing bank reverse settlement transactions to put back the borrowed discounts.
6. Note that, if the payer is signed up for the discount offer, then instead of charging the user the full amount then refunding the discount portion at a later time; this system will only debit the payer's account the net discounted amount and top off the remainder (the discount) from a borrowing pool.

The systems and methods are attractive to the payer because it allows the payer to never be charged the full settlement amount and be able to only pay the discounted amount, which is great when the payer does not have enough funds to cover the full undiscounted amount. For example, if a payer signs up for a 30% instant discount and eats at a restaurant for $100 worth, but only has $70 in their issuing bank account. Then, this system will initially settle $100 with the merchant even though the payer only has $70 in their bank account. If we were to request the payer to settle the full amount first, then refunded them the discount later; then the payer's transaction will be declined. Mainly because the transaction is $100 and the payer only has $70 available in their account. We believe that the “pay in full and get a refund later” approach, although is used by many, is inconvenient, could cause embarrassment and could lead to unnecessary quarrel between the payer and the merchant, even though both parties know that the buyer has signed up for a 30% discount, has consumed $100 worth and is only liable for $70.

The real-time discounting aspects make it a very convenient solution to both merchants and consumers.

The consumers are happy because they can now use the real-time discounting system, sign up for merchant discounts and get only charged for the discounted net amount only. Meanwhile, merchants are happy because they increase sales and customer loyalty.

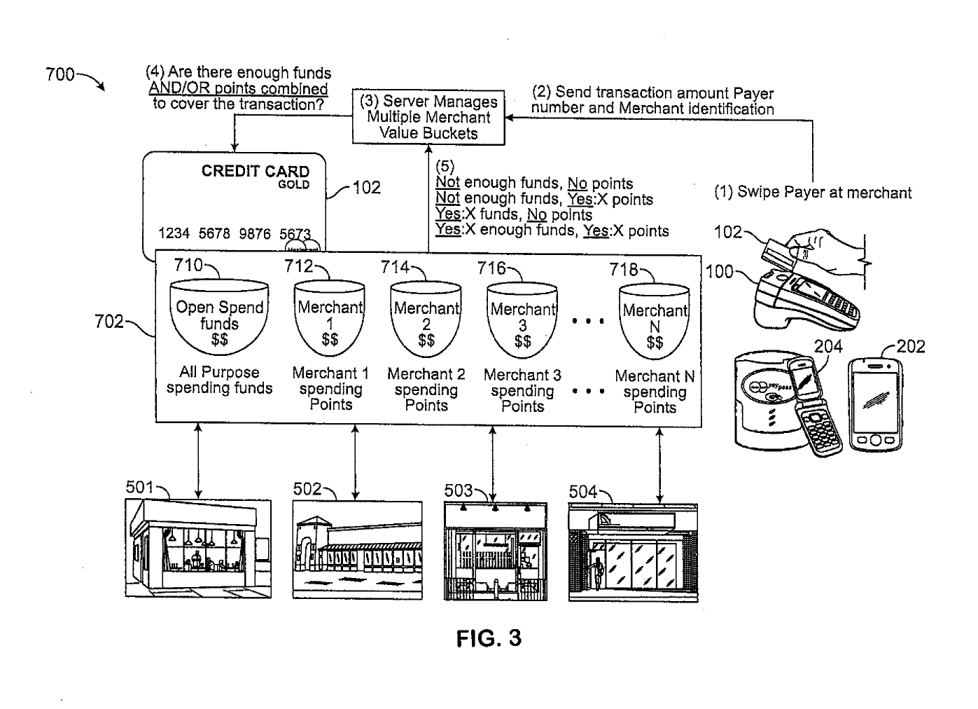

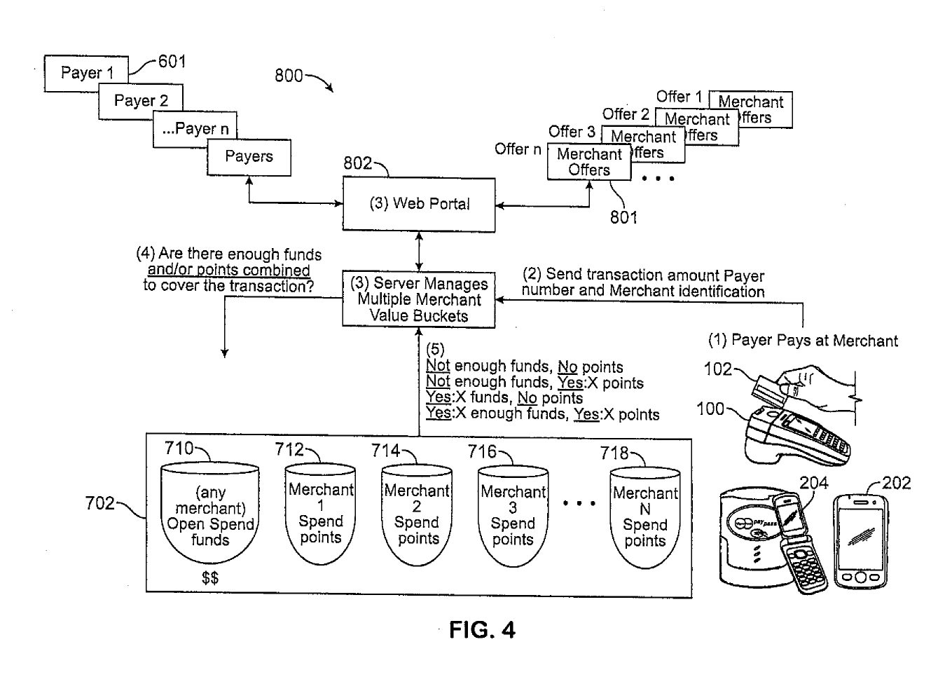

As shown in FIGS. 3 and 4, the systems and methods utilize a multi-bucket payer account 702 with Multi-Merchant Point Tracking and Discounting (MMPTD) system 800. The Multi-Merchant Point Tracking and Discounting system is an automated transaction processing system which tracks payer transactions across millions of merchants 501-504. The system 800 tracks each payer's account and allocates “multiple buckets”, where each bucket corresponds to a merchant purchase activity.

Each bucket 702 contains discount points which the payer has earned. Furthermore, the MMPTD system tracks each offer 801 which the payer 601 has signed up for, and tracks prior/current purchase activities to calculate the corresponding discount points per each bucket.

If the payer 601 is registered for a specific discount offer, then when transacting at the merchant's POS, the MMPTD system 800 will also automatically look at available points corresponding to the merchant's “bucket” 702 and makes a Yes/No decision to discount the transaction in real-time. If the payer has not signed up for any of the merchant's discounts, then the system would charge the transaction from the “all-purpose” cash bucket and the payer will pay the full amount.

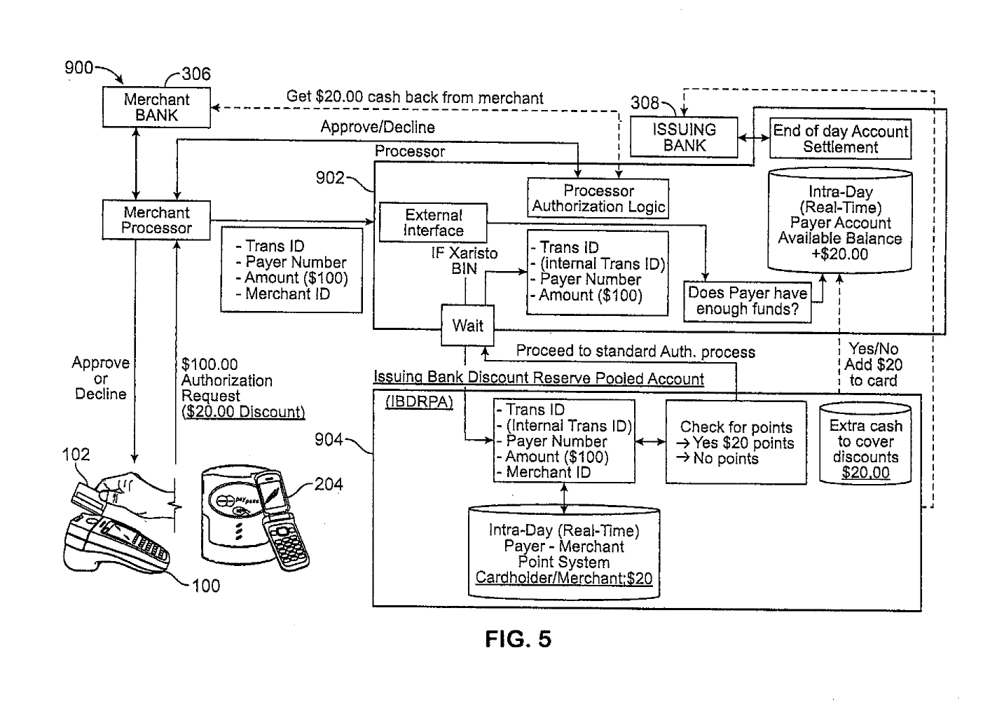

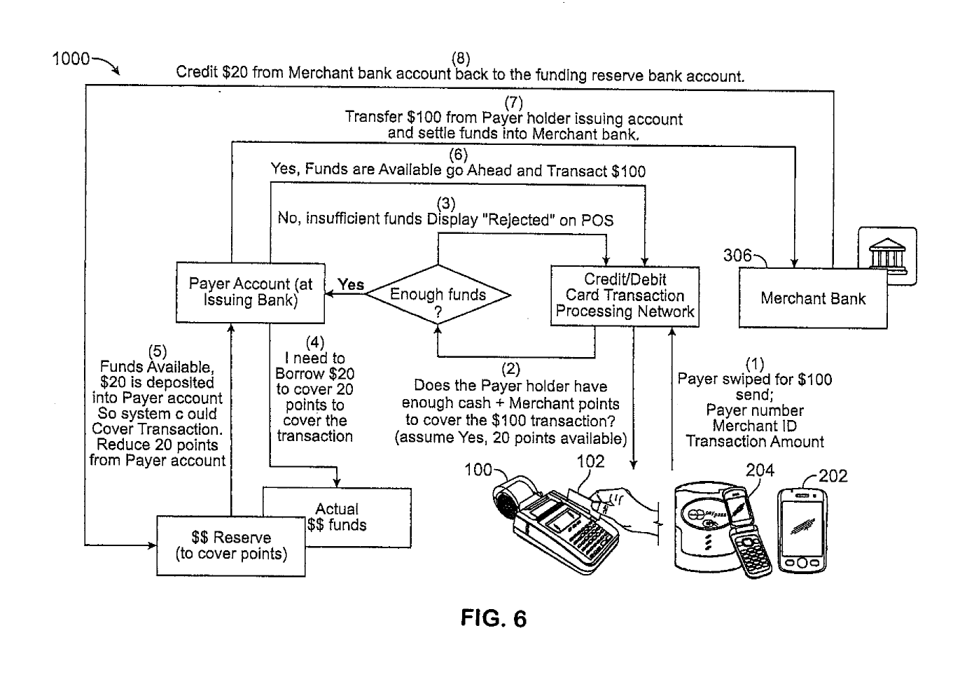

As shown in FIG. 5, the systems and methods utilize an Issuing Bank Discount Reserve Pooled Account (IBDRPA) 900. IBDRPA is a borrowing account which resides on the issuing bank side which will be used to borrow funds to offset the discounts which the payer expects to receive in a transaction, but is not willing to pay for upfront. Funds must be borrowed, and the full settlement amount must be restored in order to be able to pass the settlement transaction via a universal open loop payment network. Otherwise the universal open loop payment network would flag the inconsistency of the issuing bank's settlement transaction as being less than the expected settlement transaction by the merchant's bank, thus failing to move funds from the payer to the merchant.

To better understand the value of the IBDRPA, let's look at this more detailed sample scenario: consider a discount loyalty offer where a merchant presents clients with the following offer: “Get $20 off your next purchase if you buy $100.00 worth of goods from us this week”.
1. Let's assume that a payer has already purchased $110.00 worth of goods this week, and he/she qualifies for the discount offer upon his/her return to the store next week.
2. Upon returning to the store, the payer decides to buy a $75.00 item. However, he/she only has $60.00 in funds in his/her issuing bank card account! If the system were to authorize the full $75.00 transaction amount from the payer's account, then offer him/her the $20.00 discount post transaction (not in real-time); then the POS device will decline the transaction and our payer will have to go home empty-handed because he/she only has a $60.00 balance.
4. However, if we were to involve a short term funding source which loans the payer his/her earned $20.00 discount, and if we were to combine the $20.00 loan with the payer's $60.00 balance, thus generating an $80 total balance ($80=$20+$60); then the $75.00 transaction will be approved by the financial processor and the payer will be happy.
5. The $20.00 funding source suggested will come from the Issuing Bank Discount Reserve Pooled Account (IBDRPA).

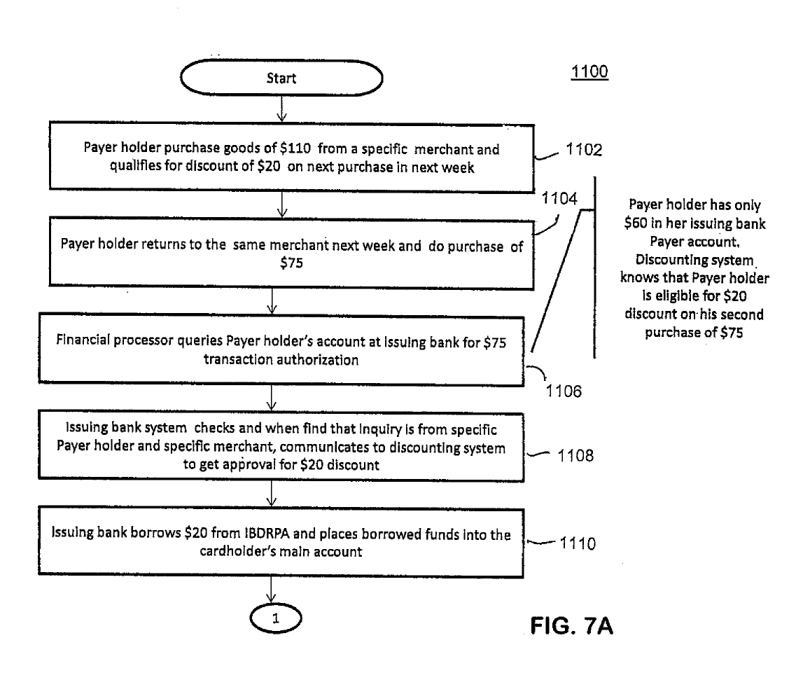

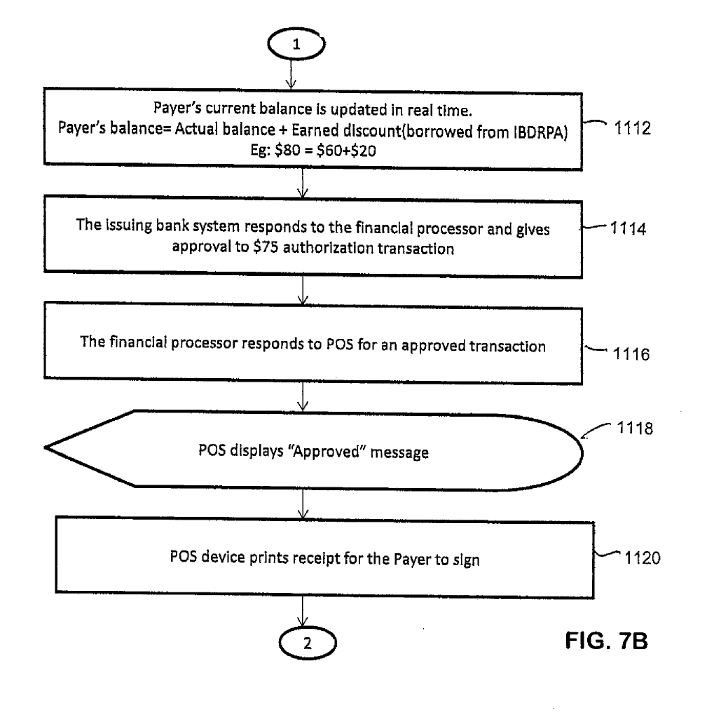

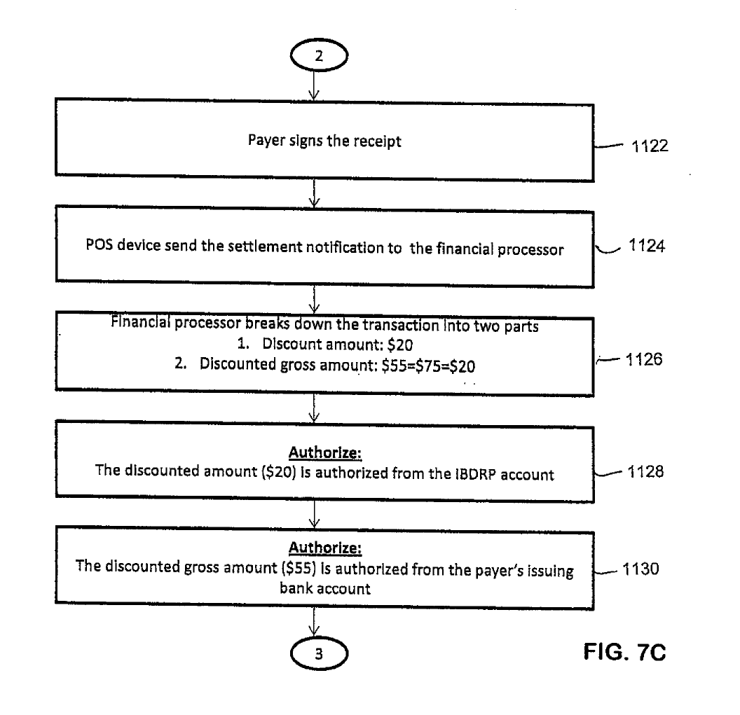

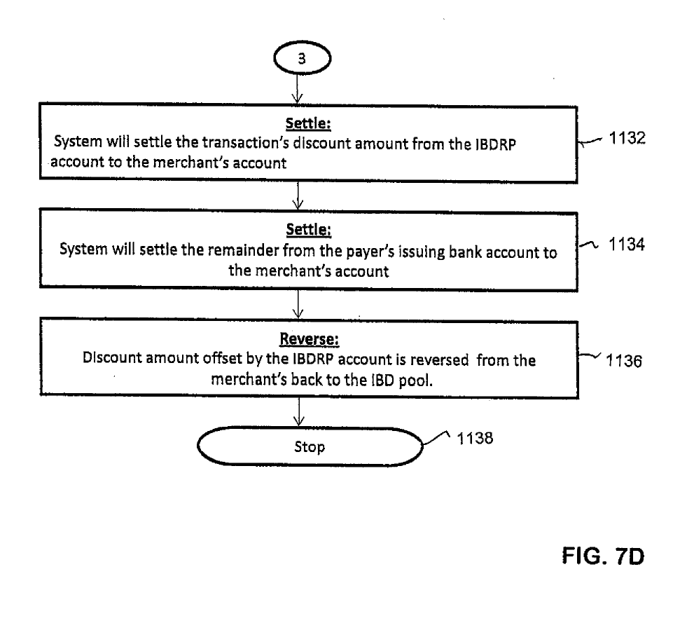

Real-Time Discounted Transaction flow using IBDRPA, As discussed earlier, our objective is to have the POS device display “Approved” on a $75.00 transaction in real-time while the payer only has $60.00 in his/her issuing bank card balance. To achieve this, here are the steps taken as shown in FIGS. 7A-7D:
1. Based on the discounting system (discussed above), we know that the user is due for a $20.00 discount (step 1102) on his/her next purchase at the specific merchant.
2. The financial processor 902 then queries to determine if the payer's account can accommodate a $75.00 transaction authorization (steps 1104 and 1106).
3. Upon receiving an inquiry from the financial processor, where the inquiry involves the specific merchant and the specific payer, the issuing bank system 308 communicates to the discounting system 904 and gets approval that the payer has earned a $20.00 discount (step 1108).
4. The issuing bank system 308 then borrows in real-time $20.00 from the IBDRPA 904, and places the borrowed funds into the payer's main account (step 1110).
5. The payer's current balance is updated in real-time, is now $80.00=$60.00 (actual balance)+$20.00 (earned discount, borrowed from the IBDRPA) (step 1112).
6. The issuing bank system 308 responds to the financial processor 902 and gives approval to the $75.00 authorization transaction (step 1114).
7. The financial processor 902 responds to the POS 100 with an approved message (step 1116). The POS displays “Approved” (step 1118) and prints a receipt for the payer to sign (step 1120). For simplicity sake, let's assume that there are no tips or additions to the $75.00 transaction.
8. The payer signs the receipt (step 1122), and leaves the merchant's location. The POS device sends a Settlement notification (step 1124).
9. Immediately after sending the approval, financial processing system breaks down the transaction into two parts: (1) the discounted amount: $20.00, and (2) the discounted gross amount: $55.00=$75.00−$20.00 (step 1126). These two values need to be known so that the amount of funds needed to settle out the payer's account is available.
10. Authorize: (i) The discounted amount is authorized (reserved and frozen) from the IBDRPA account (step 1128). (ii) The discounted gross amount is authorized (reserved and frozen) from the payer's issuing bank account (step 1130).
11. Settle: After the payer signs for the transaction, the system 900 will settle funds as follows: (i) From the IBDRPA account: Settle the transaction's discount amount from the IBDRPA account to the merchant's account (step 1132). (ii) From the payer's issuing bank account: Settle the remainder from the payer's issuing bank account to the merchant's account (step 1134).
12. Reverse: The discount amount offset by the IBDRPA account is then reversed from the merchant's account back to the IBD pool (step 1136), so that the funds could be used again to offset the discount of another transaction. The reverse transaction is actually a combined: Authorize and settle for the discount amount, except in this case the payer is the merchant and the acquirer is the IBDRPA account. Thus the reversal/refund of the borrowed discount amount from the merchant back to the IBDRPA.

In summary, the payer is given a seamless experience where the payer only pays for the discounted transaction; funds are withdrawn from the IBDRPA account; and the IBDRPA funds are used to offset the settlement of the discount portion. Then these funds are refunded back to the issuing bank.

As a result, for every open loop debit card, credit card or mobile payment device issued to a payer, a small separate IBDRPA account is created. Then, all separate discount reserve accounts are pooled in order to build a scalable multi-million user card system. This approach provides a discounting process which is seamless, automated and executed in real-time.

Payers using these real-time discounting systems and methods do not have to carry multiple gift cards, cut coupons or carry multiple loyalty cards on their key chains. All the payers need to do is to apply for a debit card, credit card or register their mobile payment device, and after being authenticated and successfully added to the system, they just log onto the discounting web portal, sign up for various merchant discounts, then visit the merchant's location or merchant's ecommerce web site, seamlessly transact the desired offers and discounts are automatically processed in real time in a hassle free manner.

In accordance with the present invention, the system and methods disclosed above are preferably integrated into a social network site, such as the well-known Facebook site at www.facebook.com; or Google+ site at www.google.com or Linkedin site at www.linkedin.com. Hereinafter, it will be understood that reference to Facebook is merely an example of a social network site and that the present invention is also applicable to other social network sites such as Twitter, Linked In and the like. Likewise, any reference to Xaristo or to Zaristo in the drawing figures is an example of one provider of an internet commerce platform which operates upon a social network.

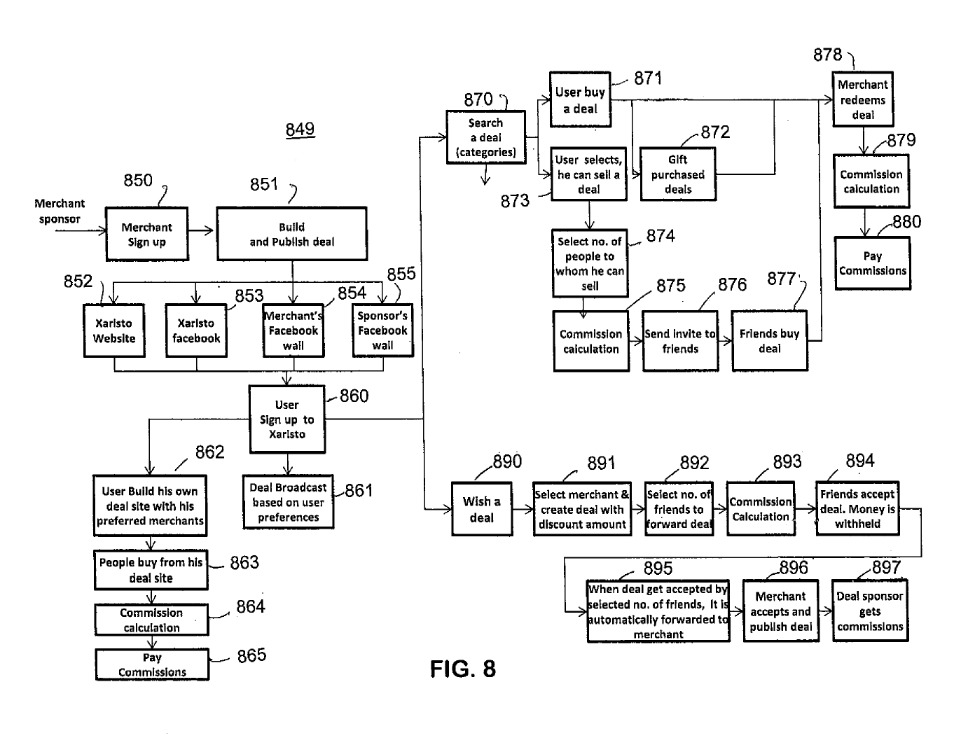

FIG. 8 illustrates a flowchart of the methods of the present invention within a social network site. A merchant may sign up (block 850) and then be able to create and publish deals on merchandize, services, or the like (block 851). These deals may then be posted and made available to users on the originator's website 852, the originator's Facebook page 853, the merchant's Facebook wall 854, and the sponsor's Facebook wall 855.

Users may see the published deals coupon discount deal on a social network site and sign up with the originator (block 860). Thereafter, deals may be broadcast to other user's based upon their preferences identified at the time that they sign up (block 861). Once signed up, a selling user may build his/her own deal site with their preferred merchants (block 862). Other user's may see the deals offered and purchase from his/her deal site (block 864). For each sale made, the user may be entitled to a commission (block 864) which is calculated by the originator. Commissions earned are then paid to the selling user (block 865).

Once signed up, a user may also search for deals, such as by searching selected categories (block 870). For example, the user may buy a deal (block 871), may purchase a gift deal (block 872), and/or can sell a deal (block 873). If selling a deal, the user can select a number of friends to sell to (block 874). The user can then earn commissions on sales (block 875) and send an invite to purchase deals (block 876). When friends buy an offered deal (block 877), the merchant redeems the deal (block 878). For each sale made, the merchant may be entitled to a commission (block 879) which is calculated by the originator. Commissions earned are then paid to the selling merchant (block 880).

When a signed up user wishes a deal (block 890), the user selects a merchant and creates a deal with a requested discount amount (block 891). The user then selects a number of friends and forwards the deal to them (block 892). The originator calculates a commission due to the user for each sale at block 893. When friends accept the deal, their money is initially withheld (block 894). When the deal gets accepted by a minimum number of friends, the deal is automatically forwarded to the merchant (block 895). If the merchant accepts and publishes the deal (block 896), sales are made to those friends who accepted the deal and the previously withheld money is forwarded to the merchant. The user who originally offered the deal is then paid a commission (block 897).

The system and methods of the present invention are advantageous to users/buyers since they can conveniently simultaneously shop while they are inside Social network while chatting with friends. Moreover, users/buyers can take advantage of various discount options including instant discounts, pre-paid discounts and loyalty based discounts. They can also refer their Facebook friends and earn money when their friends shop.

The present system and methods are also advantageous to merchants. The merchants have the opportunity of obtaining more client traffic and thus more sales. Merchants have the ability to broadcast their discount offers to a larger audience through the Facebook channel. There is no need for training on how to create deals or on how to discount transactions. The system does it automatically.

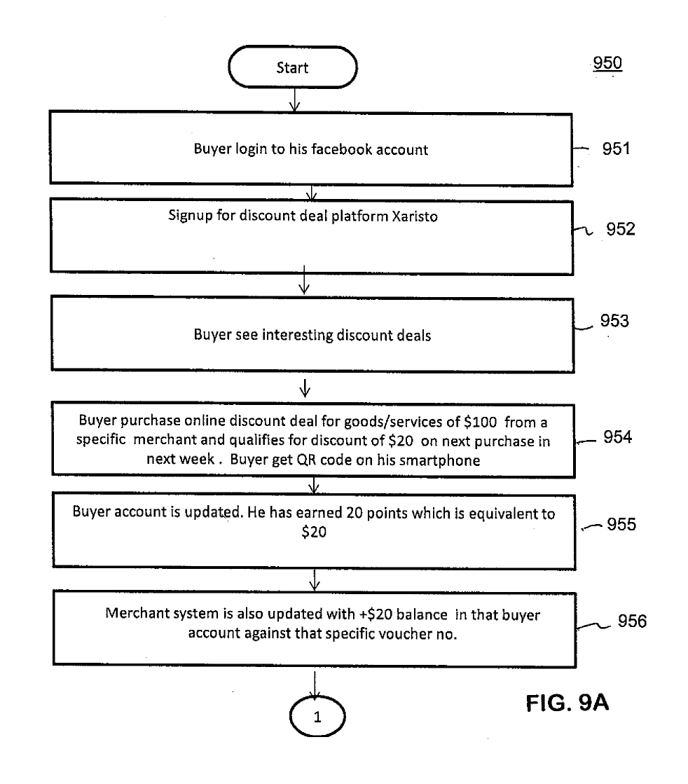

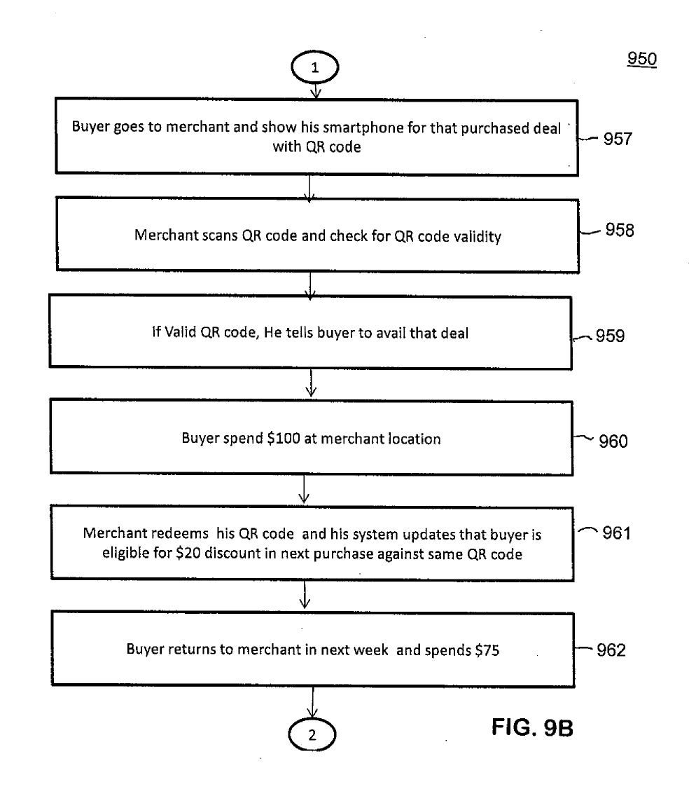

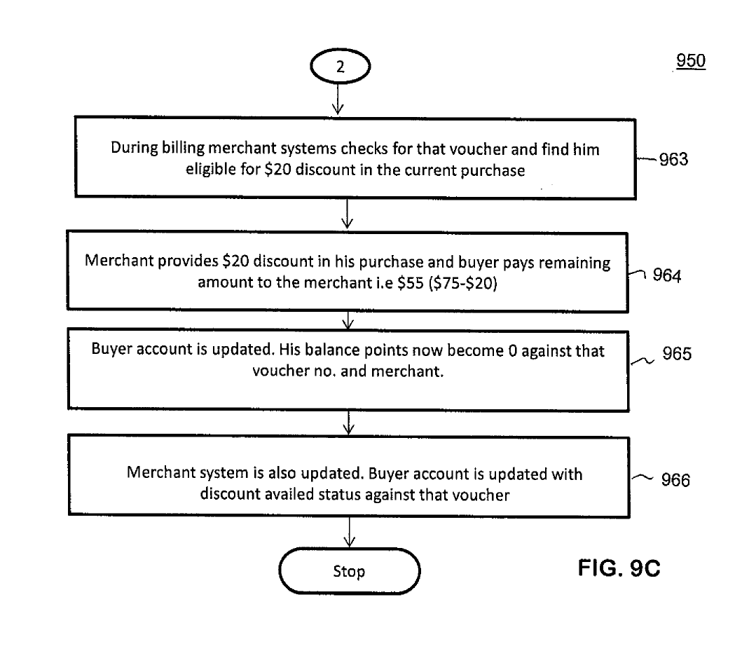

When buyers make a purchase, a QR code may be sent to their cellphone. When the buyers visit the merchant, the merchant can scan the QR code. The accepted deal will then be automatically made available for the service or product purchased.at the published discount. An example of this process which includes a loyalty-based discount on a social network site is shown in the flow charts 950 of FIGS. 9A-9C. Buyers log into their Facebook accounts (block 951) and sign up for discount deals at the originator's platform (block 952). Buyers may then see or search for interesting deals (block 953). Buyers may purchase a discount deal for $100 from a specific merchant and qualify for a $20 discount on the next purchase made within one week. Buyers then get a QR code sent to their smartphone (block 954). Buyer's accounts are updated with 20 points which is equivalent to $20 (block 955). The merchant's system is also updated with a $20 balance in the buyer's account against a specific voucher number associated with the QR code (block 956). When buyers visit a merchant and show their smartphone with the QR code (block 957), the merchant scans the QR code and checks for validity of the QR code (block 958). If the QR code is valid, the buyers are told that the deal is available (block 959). If the buyer spends $100 with the merchant (block 960), the merchant redeems the QR code and the system updates that the buyer is eligible for a $20 discount on the next purchase with the same QR code (block 961). When the buyer returns to the same merchant and spends $75 (block 962), the merchant's system finds that the buyer is eligible for a $20 discount (block 963). The $20 discount is applied to the current purchase and the buyer pays the remaining balance (block 964). The buyer's account is updated such that there is no remaining discount available with this merchant (block 965). The status of the discount available to the buyer is also updated in the merchant's system (block 966).

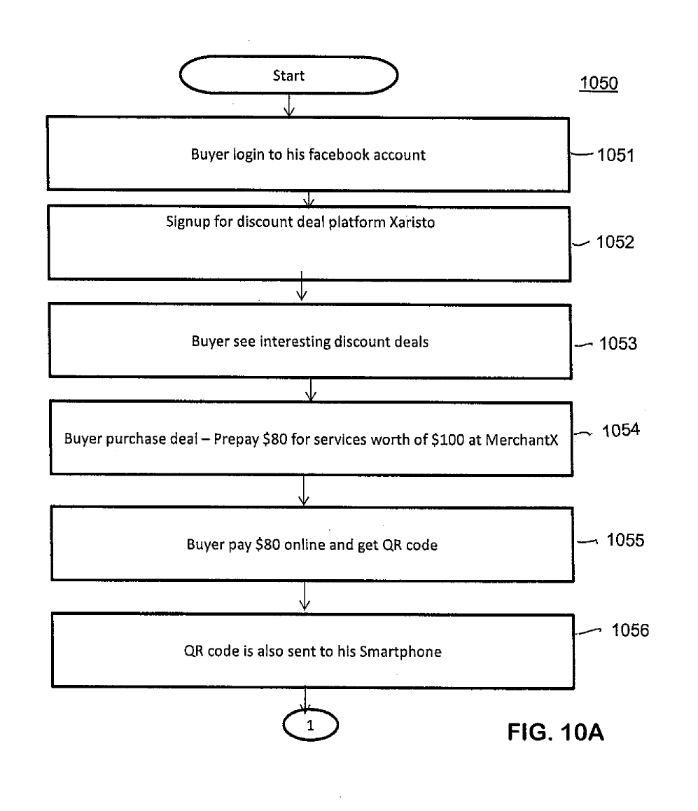

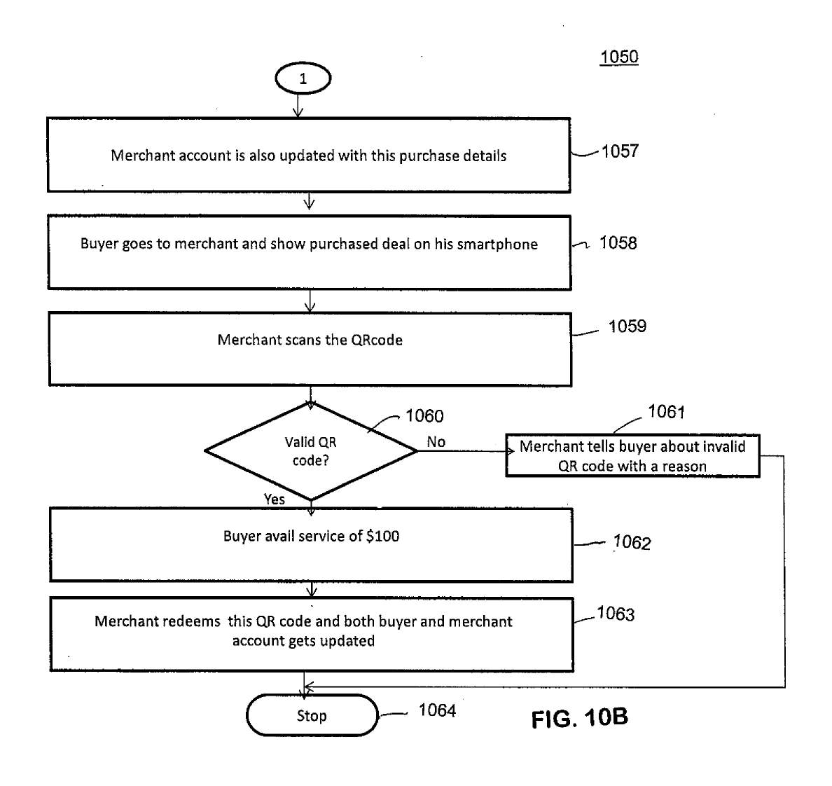

An example of a prepay discount on a social network site is shown in the flow charts 1050 of FIGS. 10A-10B. Buyers log into their Facebook accounts (block 1051) and sign up for discount deals on the originator's platform (block 1052). Buyers may then see or search for interesting deals (block 1053). Buyers may purchase a discount deal by prepaying $80 for goods or services worth $100 at a specific merchant (block 1054). Buyers then get a QR code (block 1055), which is also sent to their smartphone (block 1056). The merchant's system is updated with the purchase details (block 1057). When buyers go to the merchant and show the QR code on their smartphones (block 1058), the merchant scans the QR code (block 1059). At block 1060, a determination is made as to whether the QR code is valid. If not (block 1061), the merchant tells the buyers why the code is invalid. However, if the QR code is valid, the buyer can purchase $100 in goods or services (block 1062). During the purchase, the merchant redeems the QR code and both the buyer's and merchant's accounts are updated (block 1063).

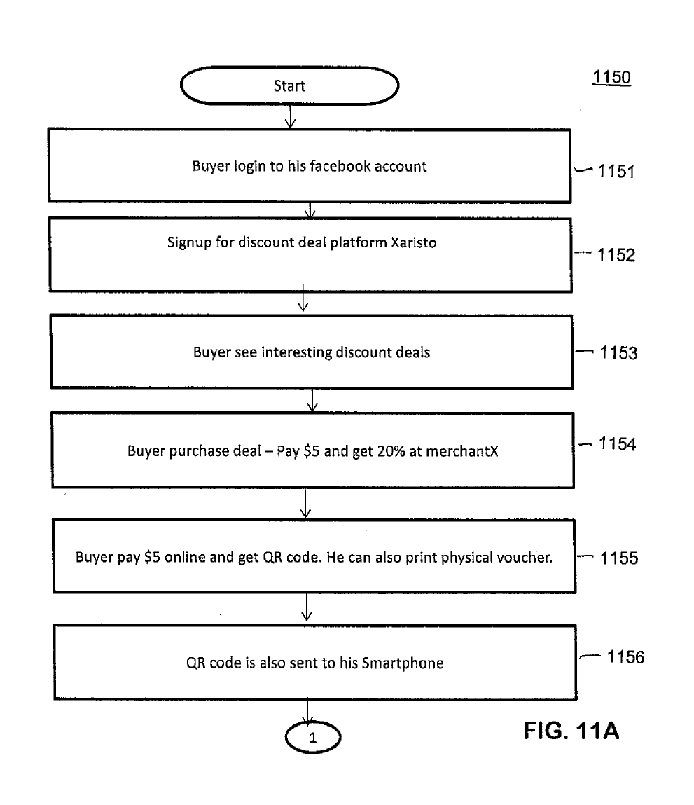

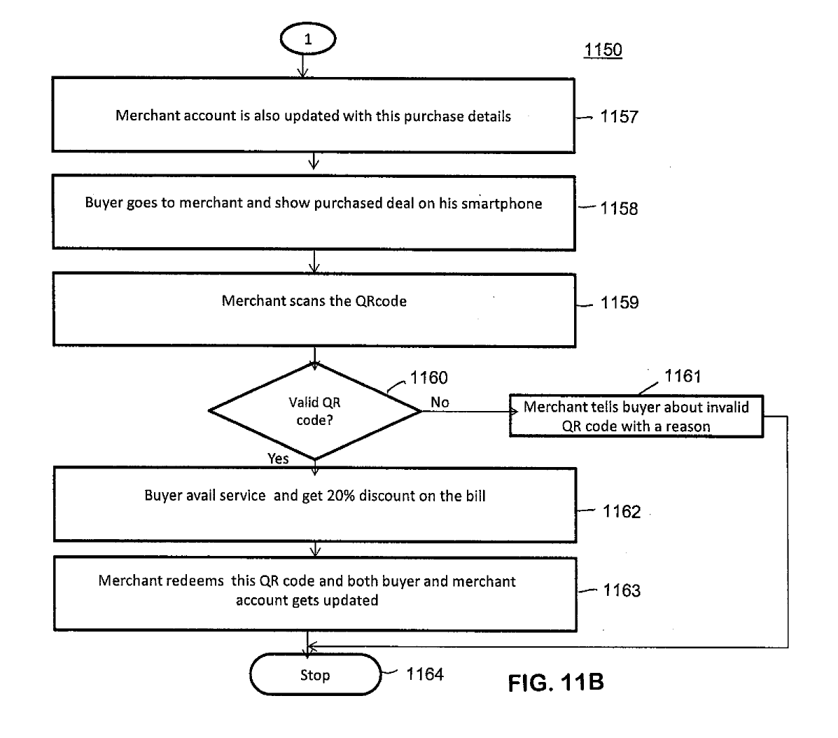

An example of a coupon discount deal on a social network site is shown in the flow charts 1150 of FIGS. 11A-11B. Buyers log into their Facebook accounts (block 1151) and sign up for discount deals on the originator's platform (block 1152). Buyers may then see or search for interesting deals (block 1153). Buyers may purchase a discount deal by prepaying $5 for goods or services and getting a 20 percent discount at a specific merchant (block 1154). Buyers then pay $5 online, get a QR code, and are enabled to print a physical voucher (block 1155). The QR code is also sent to their smartphone (block 1156). The merchant's system is updated with the purchase details (block 1157). When buyers go to the merchant and show the QR code on their smartphones (block 1158), the merchant scans the QR code (block 1159). At block 1160, a determination is made as to whether the QR code is valid. If not (block 1161), the merchant tells the buyers why the code is invalid. However, if the QR code is valid, the buyer can purchase goods or services and receive a 20 percent discount (block 1162). During the purchase, the merchant redeems the QR code and both the buyer's and merchant's accounts are updated (block 1163).

An example of a $5.00 commission, or finder's fee, defined by the merchant where in this example, the merchant offers a $5.00 finder's fee and various users either buy or forward the deal to their friends using the social network. The variable layer commission algorithm compensates those that bring real buyers, yet gives a small portion to those that forward to non-buyers but forwarders. The commission is split from 100% to various values such as an 80%-20% split through all the layers which lead to an eventual sale.

An example where the merchant offers a $5.00 finder's fee to the first user, and he is not successful in getting an immediate purchase, also referred to as a 0-layer purchase. The layer 0 (original) forwarder forwards the deal to a friend, who forwards it to another friend, who finally buys. This creates a 3-layer forward chain (layer 0, layer 1 and layer 2) which eventually results in a sale. Given the parameters of this transaction, the original forwarder gets 20% of the full commission set at $5.00: thus $1.00; Meanwhile layer-1 forwarder get 20% of the remaining 80%, thus 16% of the $5.0 commission or $0.80 this is because he also did not produce a real sale. Finally, the last layer, layer 2 gets the remaining of the commission which is 64% of the cull commission which is $3.20; because the next person has made a purchase.

An example which identifies the various players in a forward transaction, whom are as follows:
Deal wisher
Deal wisher sponsor or parent—this is the person that referred the deal wisher to the social commerce network
Merchant sponsor
Merchant sponsor's parent—this is the person that referred the merchant sponsor to the social commerce network
Eventual Buyer
Referrer to the eventual buyer: referrer to the final buyer—this person who referred the final buyer will get the most of the commission finder's fee set by the merchant.
Level-n Referrers to the eventual buyer: this is the list of referrers which eventually reach the final buyer.

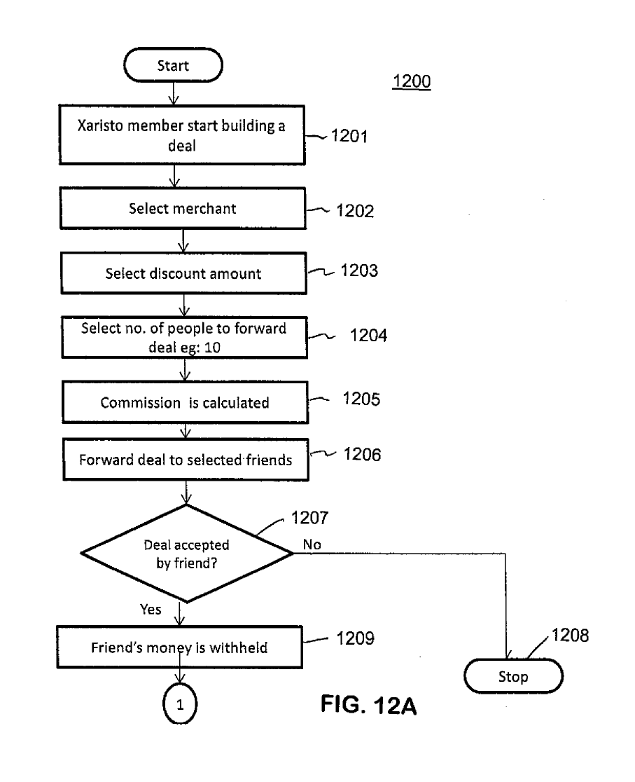

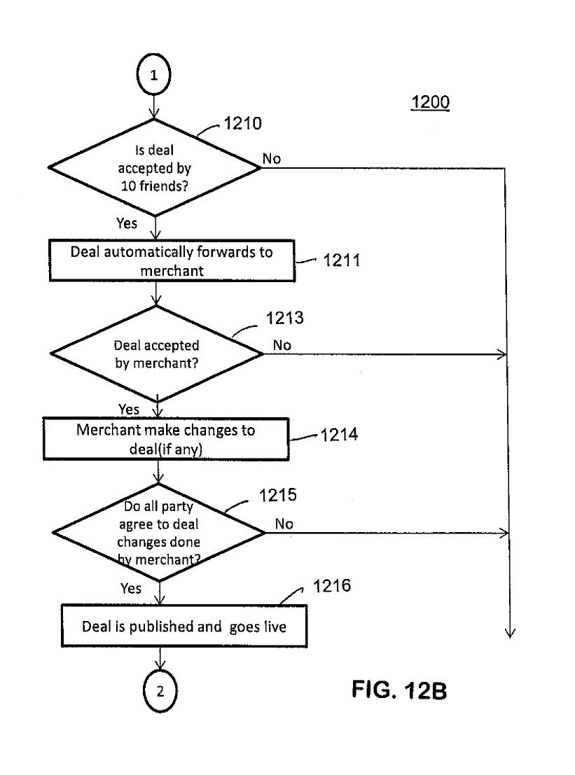

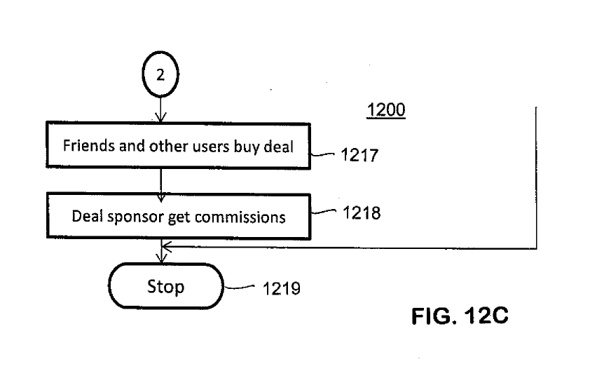

An example of how a user is enabled to wish a deal on a social network site is shown in the flow charts 1200 of FIGS. 12A-12C. At block 1201, the previously registered user starts building a deal. This includes selecting a merchant (block 1202), selecting a discount amount (block 1203), and selecting the number of other users to forward the deal to (block 1204). At block 1205, the system calculates an applicable commission for the deal. The deal is then forwarded to the selected friends at block 1206. At block 1207, the friends decide whether to accept the deal. If no, the process stops (block 1208). If yes, the friend's money for the deal is withheld (block 1209). At decision block 1208 if a minimum number of friends do not accept the deal, the deal stops (block 1219). But if the deal is accepted by a minimum number of friends, the deal is automatically forwarded to the specific merchant (block 1211). If the deal is not accepted by the merchant at block 1213, the deal terminates. But if the deal is accepted, the merchant may make some changes to the deal at block 1214. If all parties agree to the changes at block 1215, the deal is published and becomes available to the users at block 1216. Friends and other users may purchase the deal (block 1217) and the user who sponsored the deal gets commission on each sale (block 1218).

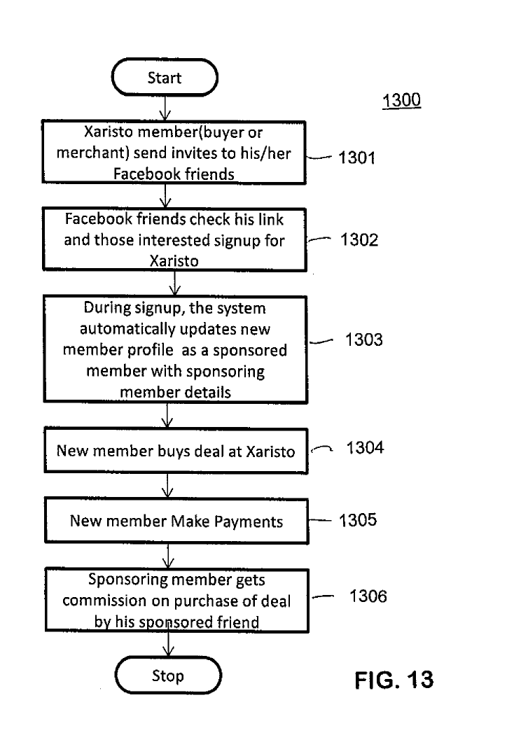

An example of how a user may sponsor friends to join an internet commerce system on a social network site is shown in the flow chart 1300 of FIG. 13. A previously registered user on the system platform of a social networking site can invite his/her friends to also join (block 1301). The invited friends check a link on the user's page and some may sign up (block 1302). The system automatically updates the new member's profile as a sponsored member with the sponsoring details (block 1303). The new members may then buy deals (block 1304) and make online payments for their purchases (block 1305). The sponsoring member then gets a commission on the purchases made by the sponsored friends (block 1306).

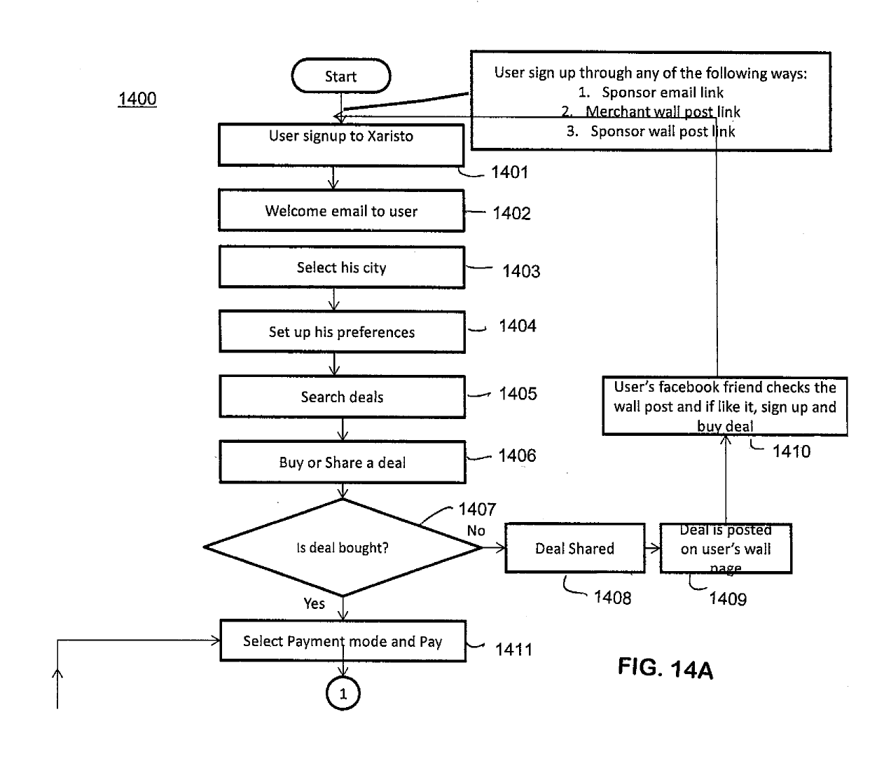

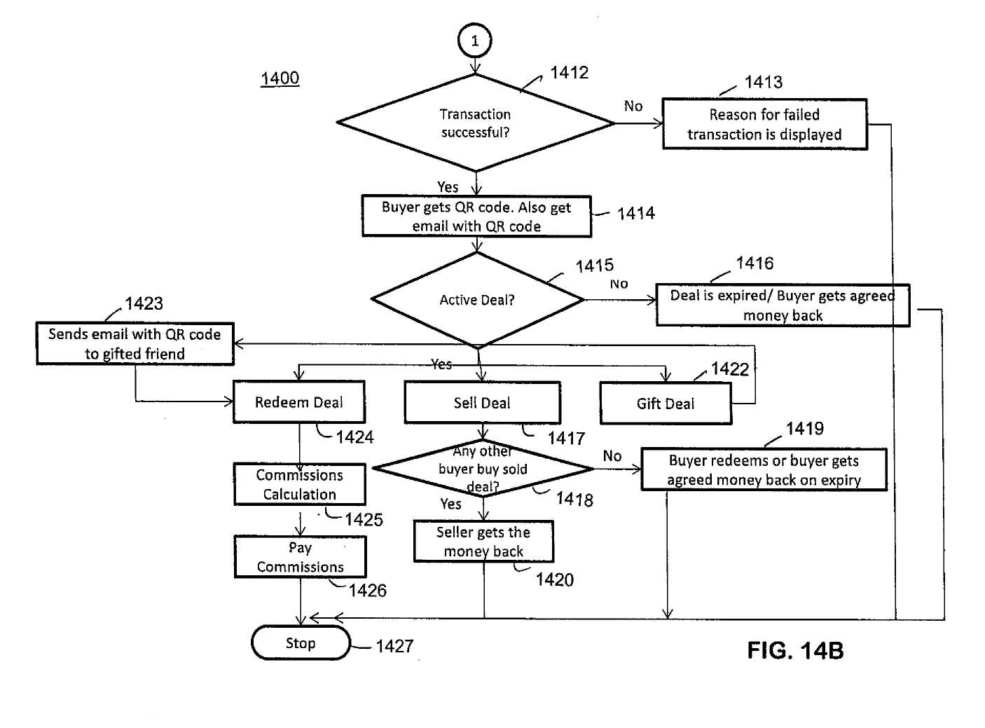

An example of how users may sign up to join an internet commerce system on a social network site and how to transact deals is shown in the flow charts 1400 of FIGS. 14A-14B. At block 1401, a new user signs up to join the internet commerce system on a social network site. The user may sign up by using a sponsor's email link, by using a merchant's wall post link, or by using a sponsor's wall post link. The user is welcomed to the system (block 1402), sets up his/her preferences (block 1404) and begins to search deals (block 1405). The user is then eligible to buy or share a deal (block 1406). If the deal is not bought but is shared (block 1408), the deal is posted on the user's wall page (block 1409). Friends of the user may then view the posted deal and purchase it (block 1410). However, if the deal is bought at block 1407, the user selects the payment mode and makes the payment (block 1411). Block 1412 determines if the transaction is successful. If not, the reason for failure may be displayed at block 1413. However, if successful, the buyer gets a QR code sent to a smartphone and may also get an email with the QR code (block 1414). Block 1415 determines if the deal is active. If the deal is expired, the buyer's money is refunded (block 1416). If the deal is current and the deal is a gift deal (block 1422), an email with the applicable QR code is sent to the intended recipient or friend (block 1423), who may then redeem the deal (block 1424). Applicable commissions are then calculated (block 1425) and paid (block 1426). If the deal is current at block 1415 and the deal is a sale at block 1418, decision block 1418 determines if another buyer sold the deal. If so, seller gets the money back (block 1420). If not, buyer can redeem the deal or buyer gets the paid money back upon expiration of the deal (block 1419).

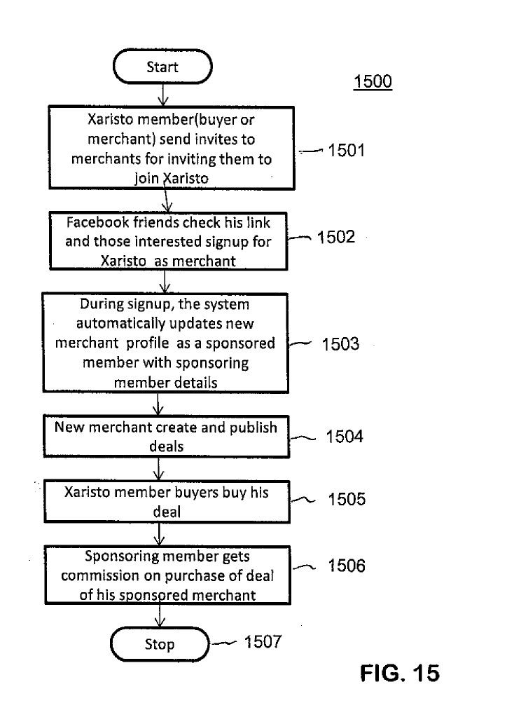

An example of how new merchants may be sponsored to join an internet commerce system on a social network site is shown in the flow chart 1500 of FIG. 15. A current member of the internet commerce system may send an invitation to a non-member merchant to join the system (block 1501). Friends may check the link of the invited merchant and any others interested in signing up as a merchant (block 1502). The system automatically updates the new merchant's profile as a sponsored member (block 1503). The new merchant may then create and publish deals (block 1504), and members may purchase the deals (block 1505). The sponsoring member then gets a commission on the purchase of deals of the sponsored merchant (block 1506).

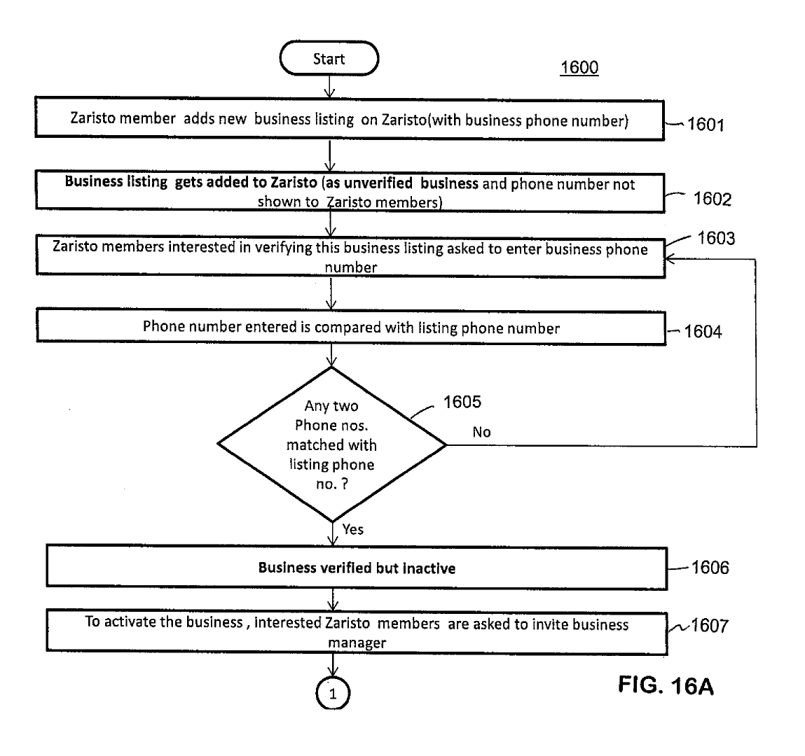

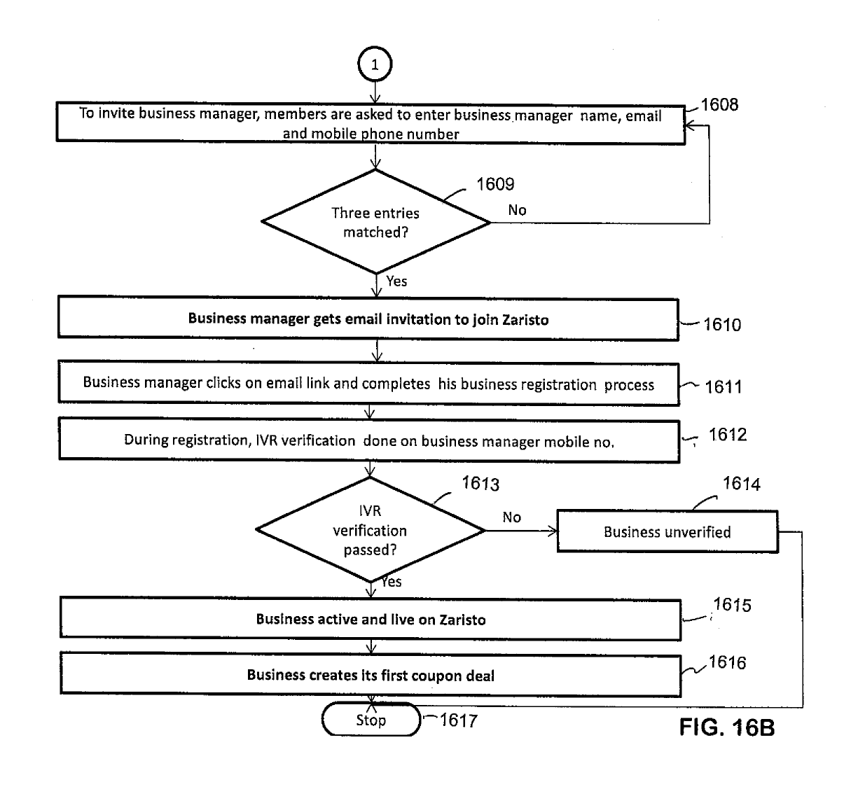

FIGS. 16A-16B is an example of how new businesses may be on-boarded to the internet commerce site by using a social network. A new business member adds a business listing on the internet commerce site of the social network at block 1601. The new business is initially listed as an unverified business and the listed telephone number is not shown to other members (block 1602). Current members may assist in the verification process by entering the telephone number of the new member (block 1603). The telephone number entered is compared to the listed number (block 1604). At decision block 1605, it is determined if any two telephone numbers match with the listed number. If not the process returns to block 1603. However, if two numbers match the listed number, the business is verified, but not yet active (block 1606). To activate the business, current members are asked to invite the business manager (block 1607) and to enter the business manager's name, email address and mobile telephone number (block 1608). After three entries match at decision block 1609, the business manager receives an invitation to join the internet commerce site (block 1610). The business manager may then click on an email link and complete the registration process (block 1611). During registration, an interactive voice response (IVR) verification is also performed on the business manager's mobile telephone number (block 1612). If the IVR verification fails (block 1614), the process stops. However, if IVR verification is successful at block 1613, the business is now active (block 1615) and may begin creating and posting deals (block 1616). The foregoing verification process is very effective at preventing fraudulent businesses from becoming listed on the internet commerce site.

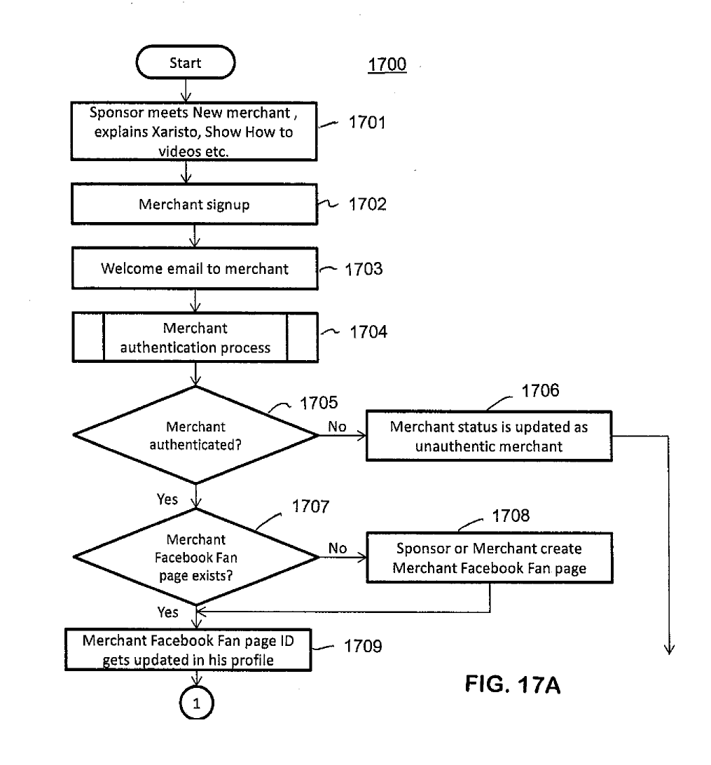

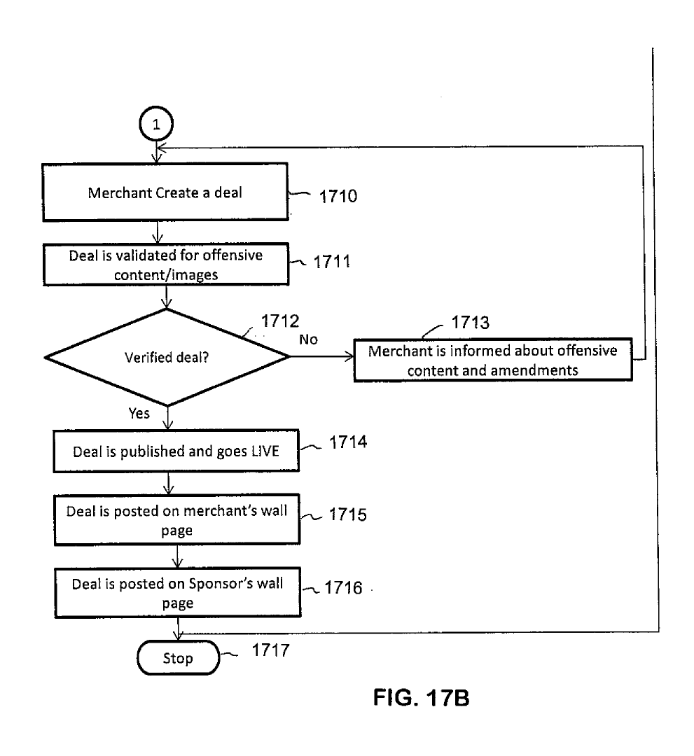

FIGS. 17A-17B are an example of how a merchant may be sponsored to sign up and how the merchant publishes deals on the internet commerce site by using a social network. At block 1701, the sponsor introduces the merchant to the internet commerce site at the social network. The merchant signs up (block 1702) and is welcomed to the system (block 1703). The merchant then undergoes an authentication or verification process (block 1704) which may be substantially the same as that presented in FIGS. 16A-16B. If the merchant is not authenticated at decision block 1705, the status is updated as unauthenticated at block 1706. However, if the merchant is authenticated, decision block 1707 determines if the merchant has a Facebook fan page. If not, the sponsor or merchant may create the fan page (block 1708). If the fan page already exists, the fan page ID is updated in the merchant's profile (block 1709). The merchant may then create a deal (block 1710) which may be validated for offensive content or images (block 1711). If the deal is not verified at decision block 1712, the merchant is advised of the offensive content and required to make amendments or revisions (block 1713). However, if the deal is verified, the deal is published and available for purchase (block 1714). The deal is posted on the merchant's wall page for buyers to review (block 1715) and the deal may also be posted on the sponsor's wall page (block 1716).

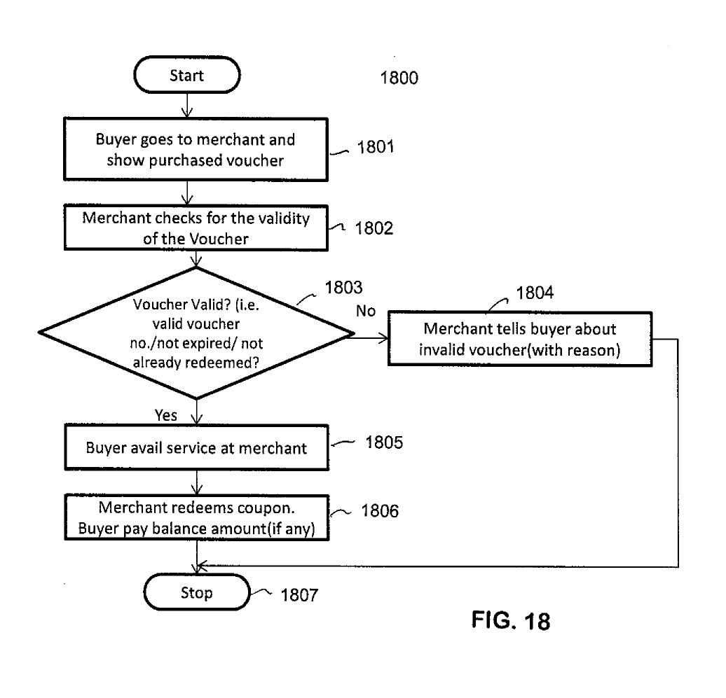

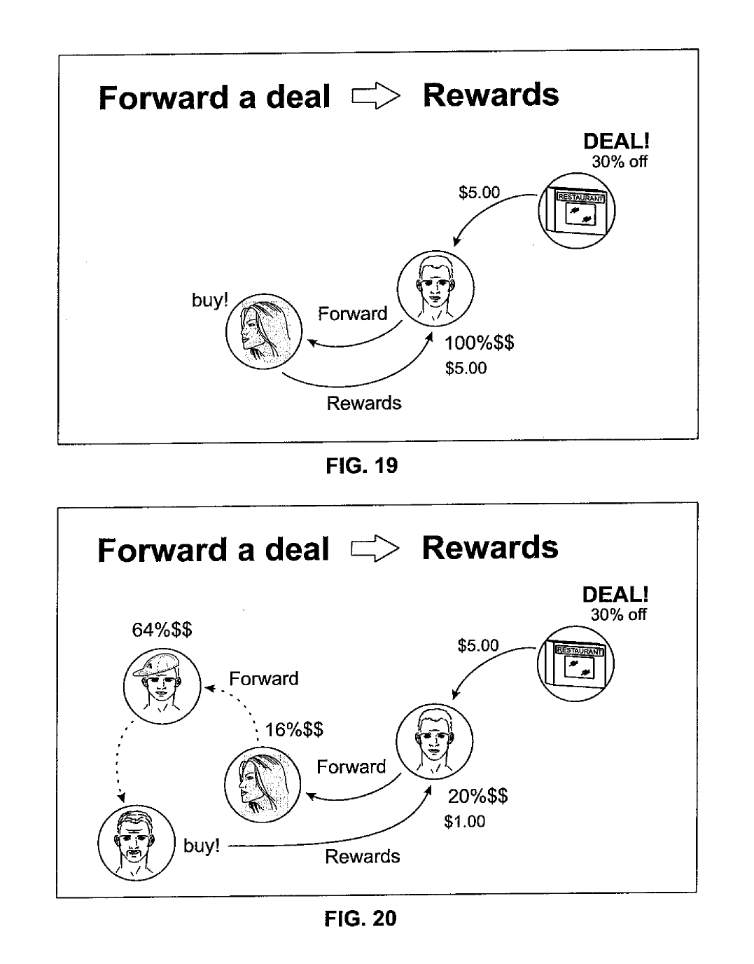

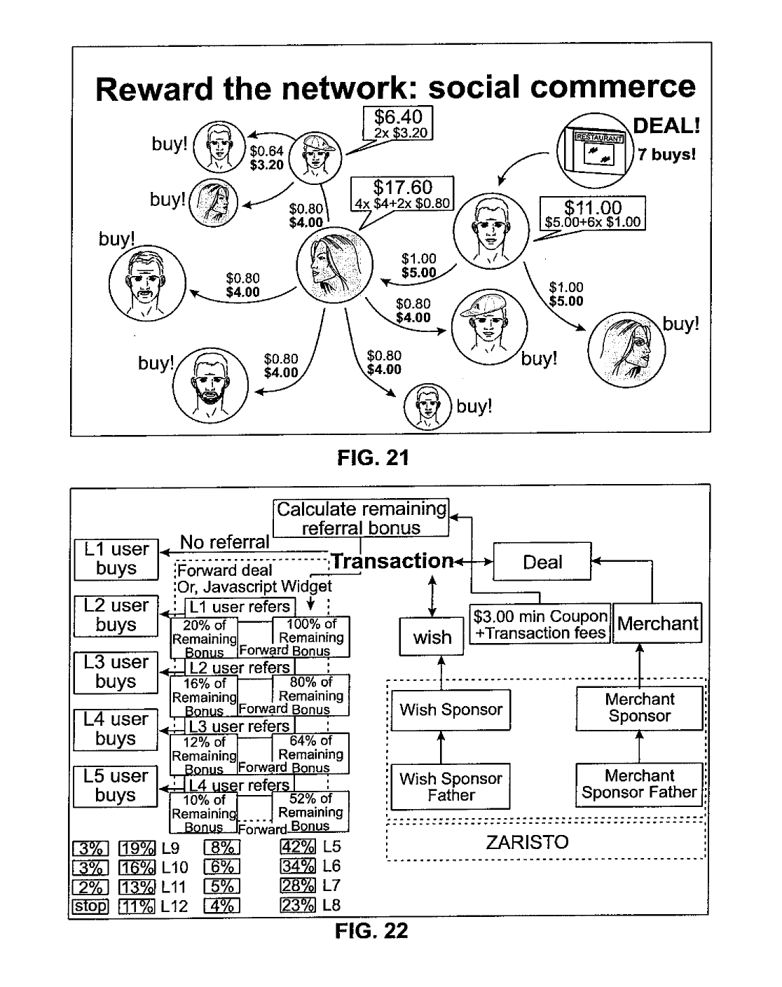

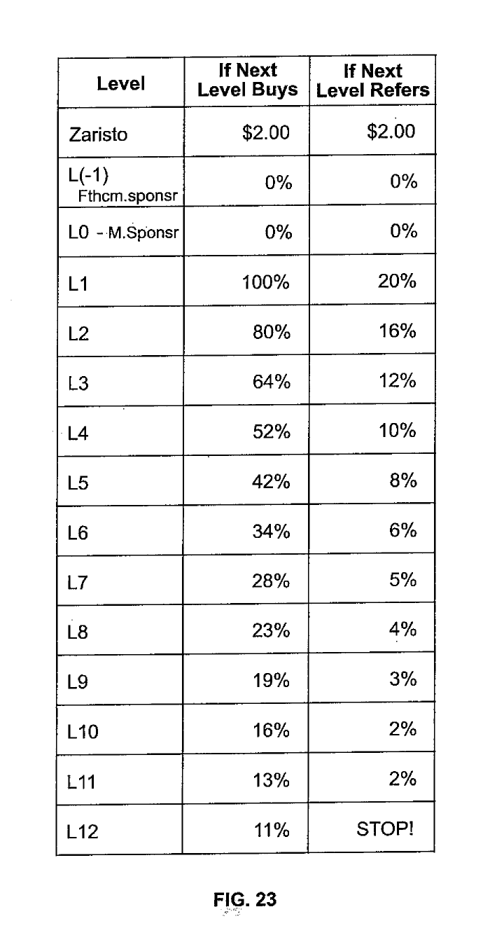

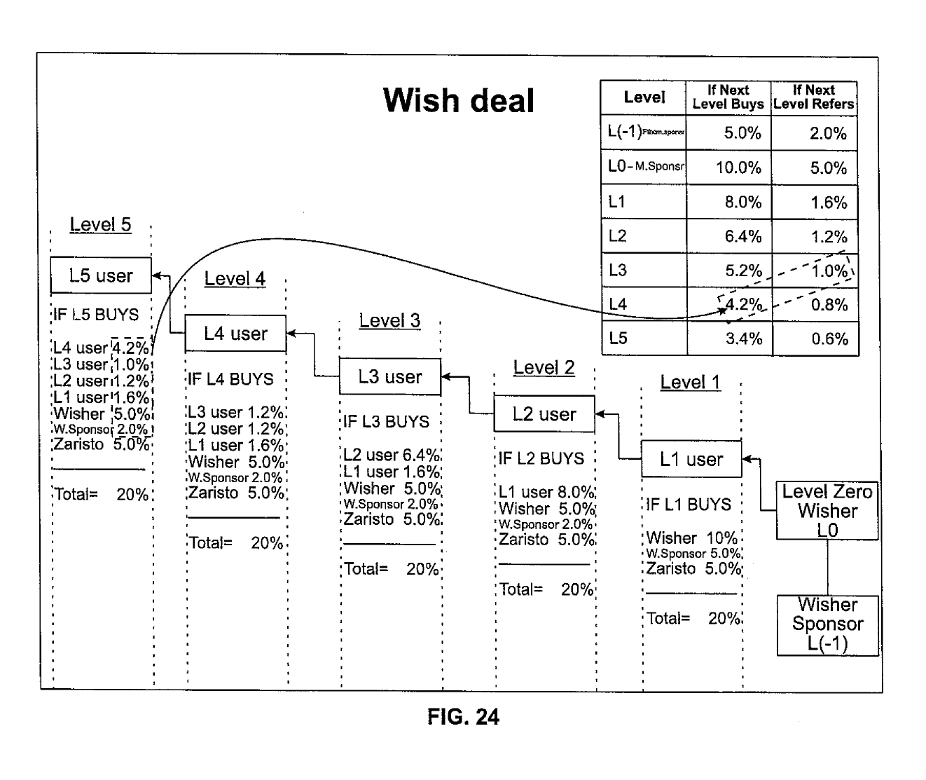

FIG. 18 is an example of the process of redeeming a voucher at a merchant on the internet commerce site by using a social network. A buyer shows a purchased voucher to a merchant who is associated with the internet commerce system on the social network (block 1801) and the merchant checks the voucher for validity (block 1802). At decision block 1803, the voucher is also checked for expiration and whether it has already been redeemed. If it is determined that the voucher is invalid, the buyer is told a reason for the invalidity (block 1804). However, if the voucher is determined to be valid, the buyer is able to purchase goods or services (block 1805), the merchant redeems the voucher and the buyer pays any remaining balance (block 1806).

In summary, a multi-user, multi-merchant, multi-bucket social commerce system and a multi-user, multi-merchant social commerce discount system is added to a social network where consumers aggregate their buying power with their friends and initiate various discounts proposals. Their deal proposals are called wishes. The wish created by the user is presented to the merchant for approval. If the merchant “grants the wish” then, users get to use the discount and our system tracks who gets the discount and how many users are granted a discount before the discount expires. The merchant could also reject the wish, in such case the users are notified that their wish was not granted.

Users can do five main activities in this platform:
1. Search for deals and products placed by various businesses, as well as deals and products suggested and wished by other members of the network.
2. Buy deals and enjoy the discounts.
3. Forward a deal. If a member is not interested in buying a deal, then he/she can receive compensation by forwarding interesting deals to their friends. Since friends know what other friends like and don't like, forwarded deals have a likelihood of being purchased.
4. Wish. The interconnected user, if they can't find a deal or product of interest, can aggregate their buying power with friends, then wish a deal onto a business. This creates a price point or discount and a volume of buyers which is then communicated to the merchant. The merchant can then agree to grant the wish, or to decline the wish. If the wish is granted, then the wisher and his/her friends are automatically billed and they can immediately use the discount (deal) which they wished.
5. Invite. Users can invite a friend or a business into the network and get compensated for adding more people to the system:
   a. Invite and sponsor a business to be part of this network of users and businesses. Then get compensated for recruiting such a business into the network via profit and revenue sharing once the business starts selling products and offering deals onto the network.
   b. Invite and sponsor a friend to be part of this network of users and businesses. Then get compensated for recruiting friends into the network via profit and revenue sharing once the friend starts buying products and offers deals from the network.

A multi-user, multi-merchant and multi-bucket social commerce system discount system utilizes “discount momentum” through a social network. “Discount momentum” is when a merchant adds a “finder's fee” which is used as fuel to push a discount or deal through an interconnected set of users in a social network. A “finder's fee commission” is intelligently split amongst merchants and buyers in a social network thus allowing more and more people to forward a deal to their interconnected friends. This helps merchants offer discounts and deals and propagate their sale through a social network. Thus, a social network of commerce is created where users create, wish and forward deals to their friends.

The ability to forward a deal through a social network, and to push such deal within the social network, and pays deal forwarders via a multi-layer commission forwarding algorithm which compensates the user that is closest to the final sale transaction, while allowing forwarders to also get a portion of the commission.

A user can place a deal on the multi-bucket, multi-user, multi-merchant social commerce platform, set a finder's fee, then use the social network to forward the deal to their friends, family members or business associates.

A user can place a product on the multi-bucket, multi-user, multi-merchant social commerce platform, set a finder's fee, then use the social network to forward the deal to their friends, family members or business associates.

A user can place a coupon, a referral link or third party reseller link on the multi-bucket, multi-user, multi-merchant social commerce platform, set a finder's fee, then use a social network to forward the deal to their friends, family members or business associates.

The present invention helps sell a product or a deal discount through a social network by helping the product, deal or transaction propagate through the social network where users forward the deal to people within their network of friends, family members and business associates. The multi-bucket, multi-user and multi-merchant social commerce system discount platform rewards both buyers and merchants.

While particular embodiments of the invention have been shown and described, it will be obvious to those skilled in the art that changes and modifications may be made therein without departing from the invention in its broader aspects.

1. A method for a buyer to receive a discount in a multi-merchant, multi-payer internet commerce platform in a social network, said method comprising the steps of:
logging in to a social network account of the buyer;
signing up for a discount deal on the internet commerce platform;
searching for discount deals of interest;
purchasing a discounted deal;
paying for the purchased deal;
receiving a code on an electronic communication device, the code is associated with the purchased deal and the code is associated with a specific merchant; and
using the code to complete the purchase with the merchant.

2. The method of claim 1 wherein the purchased deal includes a loyalty-based discount where the buyer receives a specified discount on a subsequent purchase within a specified time period.

3. The method of claim 1 wherein the buyer receives a specified discount upon prepayment of the purchased deal.

4. The method of claim 1 wherein the buyer receives a specified discount upon prepayment of the purchased deal.

5. The method of claim 1 wherein the buyer receives a physical coupon with a specified discount which can be used to obtain the discount at the specific merchant.

6. A method of wishing for a deal at a discount in a multi-merchant, multi-payer internet commerce platform in a social network, said method comprising the steps of:
selecting a merchant;
selecting a discount amount;
selecting a plurality of users to forward the deal to;
forwarding the wished deal to the plurality of selected users;
determining if the wished deal is accepted by a minimum number of selected users; and
forwarding the wished deal to the selected merchant if the wished deal is accepted by the minimum number of selected users.

7. The method of wishing for a deal in claim 6, said method comprising the further steps of:
withholding the money of those users who accepted the wished deal;
determining if the wished deal is accepted by the selected merchant; and
if so, completing the sale of the wished deal to those users who previously accepted the wished deal.

8. The method of wishing for a deal in claim 7, said method comprising the further step of:
publishing and making the wished deal available to other users of the internet commerce platform.

9. The method of wishing for a deal in claim 7, said method comprising the further step of:
determining the amount of commissions which are due to the sponsor of the wished deal; and
paying the sponsor of the wished deal the determined commissions.

10. A method of a current member sponsoring a friend or a merchant in a multi-merchant, multi-payer internet commerce platform in a social network, said method comprising the steps of:
inviting the friend or merchant to join the internet commerce platform in the social network;
the friend or merchant checking a link to the internet commerce platform in the social network for signing up; and
automatically updating a profile for the new member or merchant, including details about the sponsoring member.

11. The method for sponsoring a friend in claim 10, said method comprising the further steps of:
enabling the new member to buy deals or enabling the new merchant to sell deals on the internet commerce platform in the social network;
enabling the new member to make payments for bought deals on the internet commerce platform in the social network; and
enabling the new merchants to receive payments for sold deals on the internet commerce platform in the social network.

12. The method for sponsoring a friend in claim 10, said method comprising the further steps of:
determining the amount of commissions which are due to the sponsor of the new member for purchased deals; and
paying the sponsor of the new member the determined commissions.

13. A method of verifying a new business member in a multi-merchant, multi-payer internet commerce platform in a social network, said method comprising the steps of:
listing the new business on the internet commerce platform in a social network with a business telephone number;
listing the new business as an unverified business without displaying the business telephone number;
inviting current members to verify this new business including a business telephone number; and
determining that the business is verified if any two entered telephone numbers match the telephone number initially entered by the new business.

14. The method of verifying a new business member in claim 13, said method comprising the further steps of:
inviting current members to enter the new business manager's name, his/her email address and his/her mobile telephone number;
determining if these three entries match the entries made by other current members; and
if the three entries match, providing the business manager with an invitation to join the internet commerce platform in a social network.

15. The method of verifying a new business member in claim 14, said method comprising the further steps of:
conducting an interactive voice response verification on the business manager's mobile telephone number; and
if the interactive voice response verification passes, qualifying the new business on the internet commerce platform in a social network.
